(19) United States
(12) Patent Application Publication
(10) Pub. No.: US 2026/0205237 A1
(43) Pub. Date: Jul. 16, 2026

(54) Design of Phase Tracking Carrier and Associated CSI Feedback Mechanism for Scheduling and Configuration

(71) Applicant: Apple Inc., Cupertino, CA (US)

(72) Inventors: Sung-En Chiu, San Diego, CA (US); Xipeng Zhu, San Diego, CA (US); Sharad Sambhwani, San Diego, CA (US)

(21) Appl. No.: 19/019,372

(22) Filed: Jan. 13, 2025

(51) Int. Cl. H04L 5/00; H04W 52/02; H04W 72/232; H04W 72/542

(52) U.S. Cl. CPC H04L 5/001; H04L 5/0057; H04W 52/0212; H04W 72/232; H04W 72/542

(57) ABSTRACT

An apparatus and method of compensating for phase drift in received signals at a user equipment (UE). The method comprises receiving, at the UE, a phase tracking reference signal (PTRS) carried by a phase tracking carrier (PTC). The PTC comprises one or more component carriers of a plurality of component carriers used for carrier aggregation. The PTC is phase synchronized with one or more of the plurality of component carriers to form a phase synchronized component carrier group. The PTRS is received on a single carrier waveform or a cyclic prefix-orthogonal frequency division multiplexing (CP-OFDM) waveform. The method further comprises estimating a phase drift based on the PCT-RS, and compensating for the phase drift in one or more received signals of the component carriers in the phase synchronized component carrier group based on the estimated phase drift.

### FIELD

Embodiments of the invention relate to wireless communications, including apparatuses, systems, and methods for a phase tracking carrier and channel state information feedback for scheduling and configuration in a cellular communications network.

### DESCRIPTION OF THE RELATED ART

Wireless communication systems are used to provide various communication services such as telephone, video, data and messaging. The wireless communication systems can support communication with multiple users by sharing available system resources such as bandwidth and transmit power.

The wireless communication system may include a number of base stations (BSs) that can support communication for a number of user equipment (UEs). A BS may be referred to as a Node B, a gNB, an access point (AP), a radio head, a transmit receive point (TRP), a New Radio (NR) BS, a 5G Node B, or the like. A UE may be referred to as a wireless mobile device or cellular phone.

Telecommunication standards have been adopted to provide a common protocol to enable different UEs and BSs to communicate on a municipal, national, regional, and even global level. Wireless communication system standards and protocols can include the 3rd Generation Partnership Project (3GPP) long term evolution (LTE) (e.g., 4G), or new radio (NR) (e.g., 5G). In 3GPP radio access networks (RANs) in LTE systems, the base station can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with the UE. In fifth generation (5G) wireless RANs, RAN Nodes can include a 5G Node, or NR node (also referred to as a next generation Node B or g Node B (gNB)). In sixth generation (6G) wireless RANS, RAN nodes can include a 6G Node.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6 illustrates an example of a baseband processor architecture for a UE, according to some embodiments.

FIG. 7 illustrates an example block diagram of an interface of baseband circuitry according to some embodiments.

FIG. 8 illustrates an example block diagram of a control plane protocol stack according to some embodiments.

FIG. 9 illustrates an example block diagram of a user plane protocol stack in accordance with some embodiments.

FIG. 10 illustrates an example architecture of a system including a core network (CN) in accordance with various embodiments.

FIG. 11A illustrates an example block diagram showing inter-band and intra-band carrier aggregation (CA), in accordance with some embodiments.

FIG. 11B illustrates an example block diagram showing component carriers with a phase tracking carrier (PTC) used for carrier aggregation, in accordance with some embodiments.

FIG. 12 illustrates an example block diagram showing CA with phase synchronized component carriers (CC1-CC4), used to communicate data with a high throughput OFDM waveform, and CC5 configured as a PTC used to transmit phase tracing reference signals (with or without data) using a single carrier waveform, in accordance with some embodiments.

FIG. 13 illustrates an example block diagram showing one or more phase tracking carriers (PTC) that are configured to carry scheduled reference signals together with reference signals and data in other component carriers used to communicate data and control information, in accordance with some embodiments.

FIG. 14 illustrates an example block diagram showing phase synchronized component carriers with a phase tracking component carrier (PTC) that is a wakeup (WU) carrier, in accordance with some embodiments.

FIG. 15A illustrates an example block diagram showing a PTC with a same bandwidth as phase synchronized data component carriers (CCs), in accordance with some embodiments.

FIG. 15B illustrates an example block diagram showing a PTC with a smaller BW than the data CCs that can be phase synchronized with the PTC, in accordance with some embodiments.

FIG. 15C illustrates an example block diagram showing two PTCs in a plurality of component carriers, in accordance with some embodiments.

FIG. 16 illustrates an example table showing the benefits of carrier aggregation with a phase tracking carrier, in accordance with some embodiments.

FIG. 17 provides an example block diagram showing a comparison between phase noise compensation using 5G-NR phase tracking reference signal (PTRS) and a common phase error (CPE) de-Inter carrier interference (ICI) filter, and phase noise compensation with a PTC, according to some embodiments.

FIG. 18A illustrates an example table showing the time density of PT-RS as a function of a scheduled modulation and coding scheme (MCS), in accordance with some embodiments.

FIG. 18B illustrates an example table showing the frequency density of PT-RS as a function of scheduled bandwidth, in accordance with some embodiments.

FIG. 19 illustrates an example block diagram showing 7 CCs, with 5 data CCs and two PTC in two phase synchronized component carrier phase groups, in accordance with some embodiments.

FIG. 20 shows the original channel quality indicator (CQI)/MCS without PTC, and the CQI/MCS increase with a certain PTC BW, in accordance with some embodiments.

FIGS. 21A and 21B show example tables of PTC BW/CQI to differential CQI for various PTC bandwidths, in accordance with some embodiments.

FIG. 22 illustrates a table showing differential CQI of each bandwidth (BW) configuration, in accordance with some embodiments.

FIG. 23 illustrates a flow chart of a method for compensating for phase drift in received signals at a user equipment (UE), in accordance with some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:
Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Programmable Hardware Element includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.
Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.
User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.
Base Station—The term “Base Station” has the full breadth of its ordinary meaning, and at least includes a wireless communication station installed at a fixed location and used to communicate as part of a wireless telephone system or radio system.
Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.
Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. 5G NR can support scalable channel bandwidths from 5 MHz to 100 MHz in Frequency Range 1(FR1) and up to 400 MHz in FR2. In other radio access technologies, WLAN channels may be 22 MHz wide while Bluetooth channels may be 1 MHz wide. Other protocols and standards may include different definitions of channels. Furthermore, some standards may define and use multiple types of channels, e.g., different channels for uplink or downlink and/or different channels for different uses such as data, control information, etc.
Band—The term “band” has the full breadth of its ordinary meaning, and at least includes a section of spectrum (e.g., radio frequency spectrum) in which channels are used or set aside for the same purpose.
Legacy—The 3rd Generation Partnership Project (3GPP) produces specifications that define 3GPP technologies. 3GPP specifications cover cellular telecommunications technologies, including radio access, core network and service capabilities, which provide a complete system description for mobile telecommunications. 3GPP uses a system of parallel “Releases” that provides developers with a stable platform for the implementation of features at a given point and then allows for the addition of new functionality in subsequent releases. Release 17 was released in 2022. Release 18(Rel-18), at the time of this disclosure, is nearing release on Jun. 22, 2024, as its specifications have been largely defined. Accordingly, implementations and concepts compatible with Rel-18, or previous Releases, are sometimes referred to herein as “Legacy Releases.” One or more embodiments of the present disclosure may be adopted in future Releases, e.g., Release 19.
Phase noise—is the frequency-domain representation of random fluctuations in the phase of a waveform, corresponding to time-domain deviations from perfect periodicity (jitter).
Common phase error (CPE)—the average phase shift in an orthogonal frequency division multiplexing (OFDM) system of OFDM sub carriers due to mismatch between transmitter and receiver oscillator phases. An average drift of OFDM symbols.
Inter carrier interference (ICI)—a phenomenon where the signals on different subcarriers within an OFDM system start to interfere with each other, disrupting the orthogonality between the subcarriers. Phase fluctuations between subcarriers can disrupt the orthogonality between the subcarriers, leading to interference between adjacent subcarriers.
Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system will update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form but is not involved in the actual filling of the form (e.g., the user is not manually specifying answers to fields but rather they are being automatically completed). The present specification provides various examples of operations being automatically performed in response to actions the user has taken.
Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as set by the particular application.
Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

The example embodiments may be further understood with reference to the following description and the related appended drawings, wherein like elements are provided with the same reference numerals. The example embodiments relate to transmission of a Synchronization Signal Physical Broadcast Channel (PBCH) Block (SSB) efficiently in a smaller, e.g., 3 megahertz (MHz), channel bandwidth (BW) in 5G advance (5G-A) and 6G.

The example embodiments are described with regard to communication between a base station (or a network through the base station) and a user equipment (UE). However, reference to a base station or a UE is merely provided for illustrative purposes. The example embodiments may be utilized with any electronic component that may establish a connection to a network and is configured with the hardware, software, and/or firmware. Therefore, the base station or the UE as described herein is used to represent any appropriate type of electronic component.

The example embodiments are also described with regard to a fifth generation (5G) advanced New Radio (NR) network or a sixth generation (6G) network. However, reference to a 5G NR or 6G network is merely provided for illustrative purposes. The example embodiments may be utilized with any appropriate type of network.

Throughout this description various information elements (IEs) are referred to by specific names. It should be understood that these names are only examples and the IEs carrying the information referred to throughout this description may be referred to by other names by various entities.

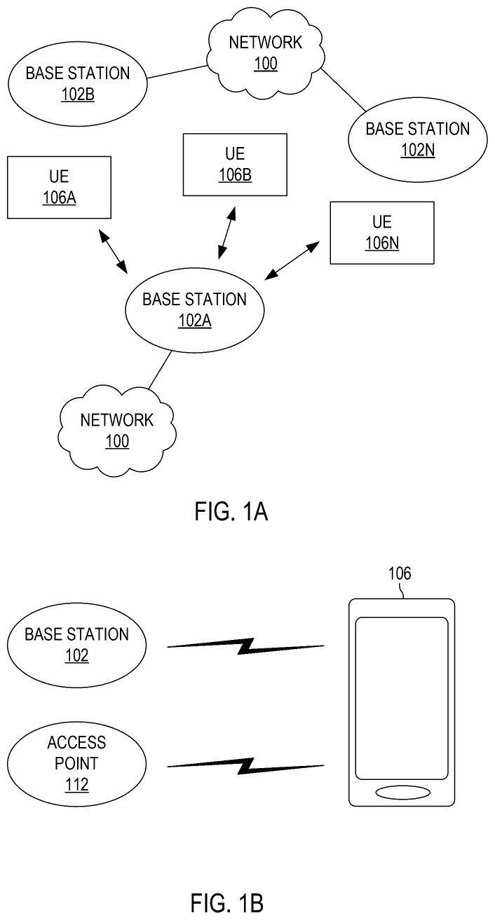

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as long term evolution (LTE), LTE-Advanced (LTE-A), 5G new radio (5G NR), 5G advance (5G-A), 6G, etc. Note that if the base station 102A is implemented in the context of LTE, also referred to as the Evolved Universal Terrestrial Radio Access Network (E-UTRAN, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B...102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1A, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1A might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., LTE, LTE-A, 5G NR, 5G-A, 6G, etc. The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 1B illustrates user equipment 106 (e.g., one of the devices 106A through 106N) in communication with a base station 102 and an access point 112, according to some embodiments. The UE 106 may be a device with both cellular communication capability and non-cellular communication capability (e.g., Bluetooth, Wi-Fi, and so forth) such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, LTE/LTE-Advanced, or 5G NR/5 G-Advanced or 6G using a single shared radio and/or LTE, LTE-Advanced, 5G NR, 5G-A, or 6G using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR, 5G-A, or 6G, and separate radios for communicating using each of Wi-Fi and Bluetooth. The UE may also include separate receive chains that are each coupled to a separate baseband processor. Other configurations are also possible.

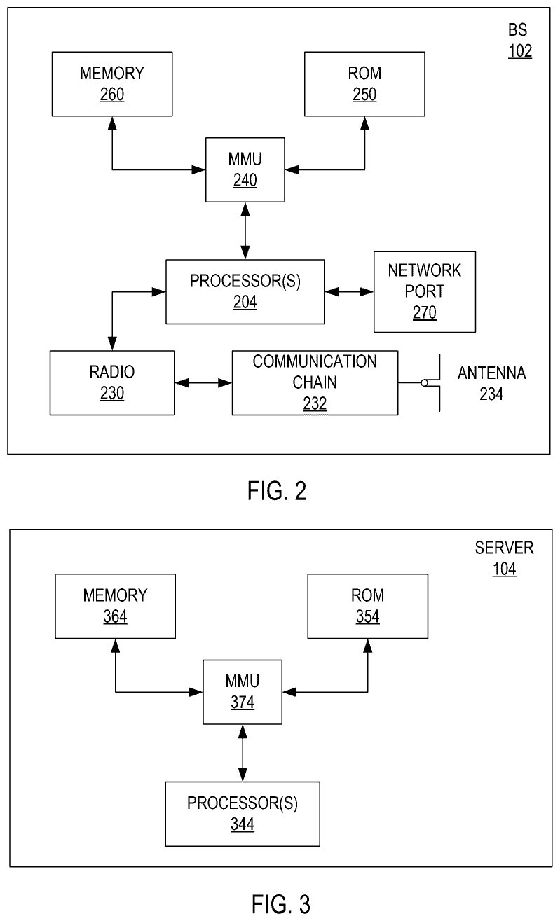

### FIG. 2: Block Diagram of a Base Station

FIG. 2 illustrates an example block diagram of a base station 102, according to some embodiments. It is noted that the base station of FIG. 2 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 6G, 5G NR, 5G-A LTE, LTE-A, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 6G, 5G-A, 5G NR and Wi-Fi, LTE etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

In some embodiments, the base station 102 and/or processors 204 thereof can be capable of and configured to receive UL data in a transmit receive operation (TRO) configured by the UE 106.

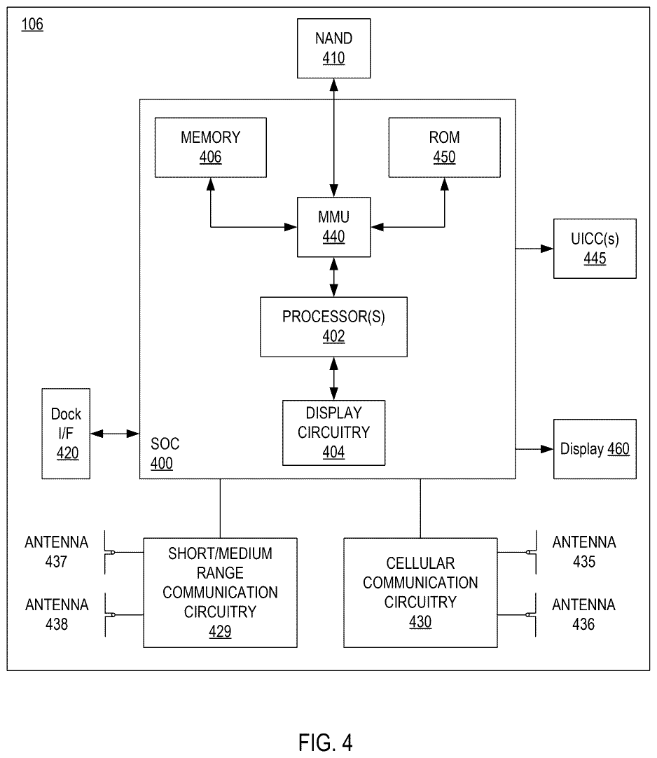

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, and UE devices 106 access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

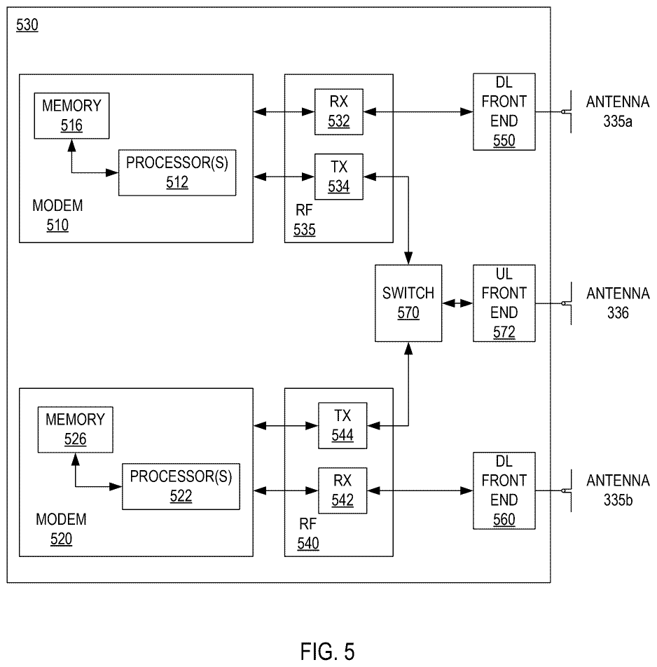

### FIG. 4: Block Diagram of a User Equipment (UE)

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 6G, 5G-A, 5G NR, LTE, etc., and short to medium range wireless communication circuitry 429 (e.g., Bluetooth™ and WLAN circuitry). In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMs 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMs may include components such as a processor and/or a memory; instructions for performing SIM/eSIM functionality may be stored in the memory and executed by the processor. In some embodiments, the UE 106 may include a combination of removable smart cards and fixed/non-removable smart cards (such as one or more eUICC cards that implement eSIM functionality), as desired. For example, the UE 106 may comprise two embedded SIMs, two removable SIMs, or a combination of one embedded SIMs and one removable SIMs. Various other SIM configurations are also contemplated.

As noted above, in some embodiments, the UE 106 may include two or more SIMs. The inclusion of two or more SIMs in the UE 106 may allow the UE 106 to support two different telephone numbers and may allow the UE 106 to communicate on corresponding two or more respective networks. For example, a first SIM may support a first RAT such as LTE, and a second SIM 410 supports a second RAT such as 5G NR. Other implementations and RATs are of course possible. In some embodiments, when the UE 106 comprises two SIMs, the UE 106 may support Dual SIM Dual Active (DSDA) functionality. The DSDA functionality may allow the UE 106 to be simultaneously connected to two networks (and use two different RATs) at the same time, or to simultaneously maintain two connections supported by two different SIMs using the same or different RATs on the same or different networks. The DSDA functionality may also allow the UE 106 to simultaneously receive voice calls or data traffic on either phone number. In certain embodiments the voice call may be a packet switched communication. In other words, the voice call may be received using voice over LTE (VoLTE) technology and/or voice over NR (VoNR) technology. In some embodiments, the UE 106 may support Dual SIM Dual Standby (DSDS) functionality. The DSDS functionality may allow either of the two SIMs in the UE 106 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

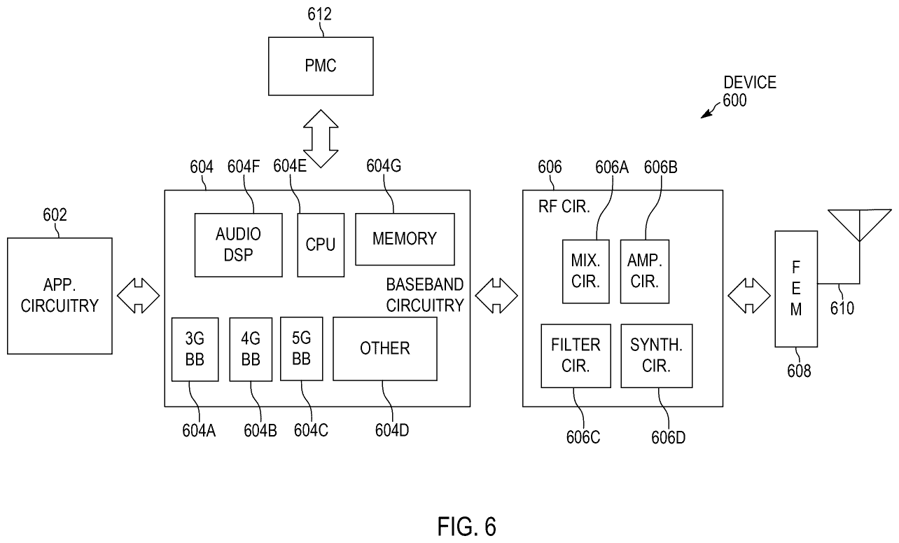

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular communication circuitry 430, may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 530 may couple (e.g., communicatively; directly or indirectly) to one or more antennas, such as antennas 435a-b and 436 as shown (in FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335a, 335b, and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335a, 335b, and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

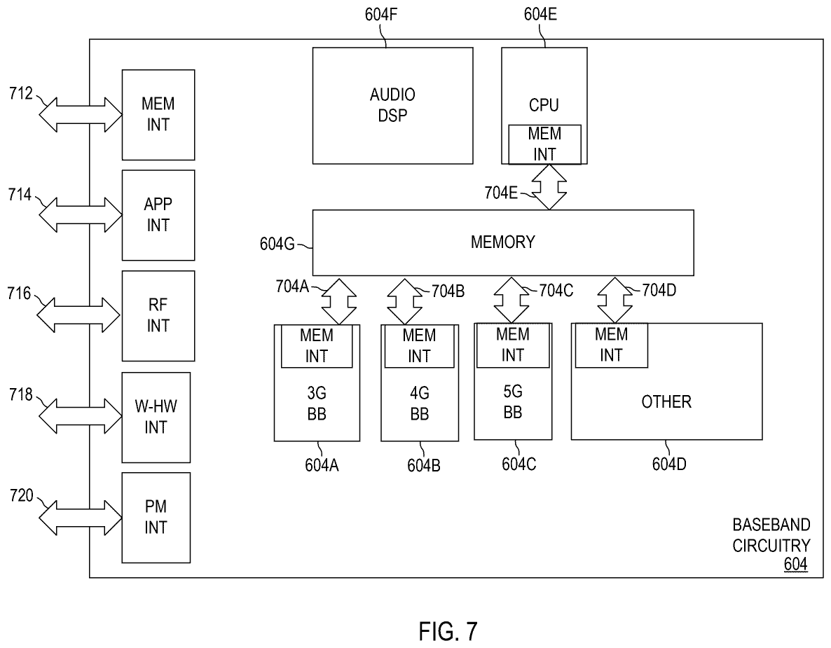

### FIG. 6: Block Diagram of a Baseband Processor Architecture for a UE

FIG. 6 illustrates example components of a device 600 in accordance with some embodiments. It is noted that the device of FIG. 6 is merely one example of a possible system, and that features of this disclosure may be implemented in any of various UEs, as desired.

In some embodiments, the device 600 may include application circuitry 602, baseband circuitry 604, Radio Frequency (RF) circuitry 606, front-end module (FEM) circuitry 608, one or more antennas 610, and power management circuitry (PMC) 612 coupled together at least as shown. The components of the illustrated device 600 may be included in a UE 106 or a RAN node. In some embodiments, the device 600 may include less elements (e.g., a RAN node may not utilize application circuitry 602 and instead include a processor/controller to process IP data received from an EPC). In some embodiments, the device 600 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 602 may include one or more application processors. For example, the application circuitry 602 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 600. In some embodiments, processors of application circuitry 602 may process IP data packets received from an EPC.

The baseband circuitry 604 may include circuitry such as, but not limited to, one or more single-core or multi-core processors. The baseband circuitry 604 may include one or more baseband processors or control logic to process baseband signals received from a receive signal path of the RF circuitry 606 and to generate baseband signals for a transmit signal path of the RF circuitry 606. Baseband processing circuity 604 may interface with the application circuitry 602 for generation and processing of the baseband signals and for controlling operations of the RF circuitry 606. For example, in some embodiments, the baseband circuitry 604 may include a third generation (3G) baseband processor 604A, a fourth generation (4G) baseband processor 604B, a fifth generation (5G) baseband processor 604C, or other baseband processor(s) 604D for other existing generations, generations in development or to be developed in the future (e.g., second generation (2G), sixth generation (6G), etc.). The baseband circuitry 604 (e.g., one or more of baseband processors 604A-D) may handle various radio control functions that enable communication with one or more radio networks via the RF circuitry 606. In other embodiments, some or all of the functionality of baseband processors 604A-D may be included in modules stored in the memory 604G and executed via a Central Processing Unit (CPU) 604E. The radio control functions may include, but are not limited to, signal modulation/demodulation, encoding/decoding, radio frequency shifting, etc. In some embodiments, modulation/demodulation circuitry of the baseband circuitry 604 may include Fast-Fourier Transform (FFT), precoding, or constellation mapping/demapping functionality. In some embodiments, encoding/decoding circuitry of the baseband circuitry 604 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 604 may include one or more audio digital signal processor(s) (DSP) 604F. The audio DSP(s) 604F may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 604 and the application circuitry 602 may be implemented together such as, for example, on a system on a chip (SOC).

In some embodiments, the baseband circuitry 604 may provide for communication compatible with one or more radio technologies. For example, in some embodiments, the baseband circuitry 604 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 604 is configured to support radio communications of more than one wireless protocol may be referred to as multi-mode baseband circuitry.

RF circuitry 606 may enable communication with wireless networks using modulated electromagnetic radiation through a non-solid medium. In various embodiments, the RF circuitry 606 may include switches, filters, amplifiers, etc. to facilitate the communication with the wireless network. RF circuitry 606 may include a receive signal path which may include circuitry to down-convert RF signals received from the FEM circuitry 608 and provide baseband signals to the baseband circuitry 604. RF circuitry 606 may also include a transmit signal path which may include circuitry to up-convert baseband signals provided by the baseband circuitry 604 and provide RF output signals to the FEM circuitry 608 for transmission.

In some embodiments, the receive signal path of the RF circuitry 606 may include mixer circuitry 606a, amplifier circuitry 606b and filter circuitry 606c. In some embodiments, the transmit signal path of the RF circuitry 606 may include filter circuitry 606c and mixer circuitry 606a. RF circuitry 606 may also include synthesizer circuitry 606d for synthesizing a frequency for use by the mixer circuitry 606a of the receive signal path and the transmit signal path. In some embodiments, the mixer circuitry 606a of the receive signal path may be configured to down-convert RF signals received from the FEM circuitry 608 based on the synthesized frequency provided by synthesizer circuitry 606d. The amplifier circuitry 606b may be configured to amplify the down-converted signals and the filter circuitry 606c may be a low-pass filter (LPF) or band-pass filter (BPF) configured to remove unwanted signals from the down-converted signals to generate output baseband signals. Output baseband signals may be provided to the baseband circuitry 604 for further processing. In some embodiments, the output baseband signals may be zero-frequency baseband signals, although this is not a necessity. In some embodiments, mixer circuitry 606a of the receive signal path may comprise passive mixers, although the scope of the embodiments is not limited in this respect.

In some embodiments, the mixer circuitry 606a of the transmit signal path may be configured to up-convert input baseband signals based on the synthesized frequency provided by the synthesizer circuitry 606d to generate RF output signals for the FEM circuitry 608. The baseband signals may be provided by the baseband circuitry 604 and may be filtered by filter circuitry 606c.

In some embodiments, the mixer circuitry 606a of the receive signal path and the mixer circuitry 606a of the transmit signal path may include two or more mixers and may be arranged for quadrature downconversion and upconversion, respectively. In some embodiments, the mixer circuitry 606a of the receive signal path and the mixer circuitry 606a of the transmit signal path may include two or more mixers and may be arranged for image rejection (e.g., Hartley image rejection). In some embodiments, the mixer circuitry 606a of the receive signal path and the mixer circuitry 606a may be arranged for direct downconversion and direct upconversion, respectively. In some embodiments, the mixer circuitry 606a of the receive signal path and the mixer circuitry 606a of the transmit signal path may be configured for super-heterodyne operation.

In some embodiments, the output baseband signals, and the input baseband signals may be analog baseband signals, although the scope of the embodiments is not limited in this respect. In some alternate embodiments, the output baseband signals, and the input baseband signals may be digital baseband signals. In these alternate embodiments, the RF circuitry 606 may include analog-to-digital converter (ADC) and digital-to-analog converter (DAC) circuitry and the baseband circuitry 604 may include a digital baseband interface to communicate with the RF circuitry 606.

In some dual-mode embodiments, a separate radio IC circuitry may be provided for processing signals for each spectrum, although the scope of the embodiments is not limited in this respect.

In some embodiments, the synthesizer circuitry 606d may be a fractional-N synthesizer or a fractional N/N+1 synthesizer, although the scope of the embodiments is not limited in this respect as other types of frequency synthesizers may be suitable. For example, synthesizer circuitry 606d may be a delta-sigma synthesizer, a frequency multiplier, or a synthesizer comprising a phase-locked loop with a frequency divider.

The synthesizer circuitry 606d may be configured to synthesize an output frequency for use by the mixer circuitry 606a of the RF circuitry 606 based on a frequency input and a divider control input. In some embodiments, the synthesizer circuitry 606d may be a fractional N/N+1 synthesizer.

In some embodiments, frequency input may be provided by a voltage controlled oscillator (VCO), although that is not a necessity. Divider control input may be provided by either the baseband circuitry 604 or the applications processor 602 depending on the desired output frequency. In some embodiments, a divider control input (e.g., N) may be determined from a look-up table based on a channel indicated by the applications processor 602.

Synthesizer circuitry 606d of the RF circuitry 606 may include a divider, a delay-locked loop (DLL), a multiplexer and a phase accumulator. In some embodiments, the divider may be a dual modulus divider (DMD), and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 606d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 606 may include an IQ/polar converter.

FEM circuitry 608 may include a receive signal path which may include circuitry configured to operate on RF signals received from one or more antennas 610, amplify the received signals and provide the amplified versions of the received signals to the RF circuitry 606 for further processing. FEM circuitry 608 may also include a transmit signal path which may include circuitry configured to amplify signals for transmission provided by the RF circuitry 606 for transmission by one or more of the one or more antennas 610. In various embodiments, the amplification through the transmit or receive signal paths may be done solely in the RF circuitry 606, solely in the FEM 608, or in both the RF circuitry 606 and the FEM 608.

In some embodiments, the FEM circuitry 608 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 606). The transmit signal path of the FEM circuitry 608 may include a power amplifier (PA) to amplify input RF signals (e.g., provided by RF circuitry 606), and one or more filters to generate RF signals for subsequent transmission (e.g., by one or more of the one or more antennas 610).

In some embodiments, the PMC 612 may manage power provided to the baseband circuitry 604. In particular, the PMC 612 may control power-source selection, voltage scaling, battery charging, or DC-to-DC conversion. The PMC 612 may often be included when the device 600 is capable of being powered by a battery, for example, when the device is included in a UE. The PMC 612 may increase the power conversion efficiency while providing desirable implementation size and heat dissipation characteristics.

While FIG. 6 shows the PMC 612 coupled only with the baseband circuitry 604, in other embodiments the PMC 612 may be additionally or alternatively coupled with, and perform similar power management operations for, other components such as, but not limited to, application circuitry 602, RF circuitry 606, or FEM 608.

In some embodiments, the PMC 612 may control, or otherwise be part of, various power saving mechanisms of the device 600. For example, if the device 600 is in a radio resource control_Connected (RRC_Connected) state, where it is still connected to the RAN node as it expects to receive traffic shortly, then it may enter a state known as Discontinuous Reception Mode (DRX) after a period of inactivity. During this state, the device 600 may power down for brief intervals of time and thus save power.

If there is no data traffic activity for an extended period of time, then the device 600 may transition off to an RRC_Idle state, where it disconnects from the network and does not perform operations such as channel quality feedback, handover, etc. The device 600 goes into a very low power state and it performs paging where again it periodically wakes up to listen to the network and then powers down again. The device 600 may not receive data in this state, in order to receive data, it will transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 602 and processors of the baseband circuitry 604 may be used to execute elements of one or more instances of a protocol stack. For example, processors of the baseband circuitry 604, alone or in combination, may be used execute Layer 3, Layer 2, or Layer 1 functionality, while processors of the application circuitry 604 may utilize data (e.g., packet data) received from these layers and further execute Layer 4 functionality (e.g., transmission communication protocol (TCP) and user datagram protocol (UDP) layers). As referred to herein, Layer 3 (L3) may comprise a radio resource control (RRC) layer, described in further detail below. As referred to herein, Layer 2 (L2) may comprise a medium access control (MAC) layer, a radio link control (RLC) layer, and a packet data convergence protocol (PDCP) layer, described in further detail below. As referred to herein, Layer 1 (L1) may comprise a physical (PHY) layer of a UE/RAN node, described in further detail below. Accordingly, the baseband circuitry 604 can be used to encode a message for transmission between a UE and a gNB, or decode a message received between a UE and a gNB.

For example, the baseband circuitry 604 can be used to encode and transmit, at the base station 102, a phase tracking reference signal (PTRS) carried by a phase tracking carrier (PTC). In addition, baseband circuitry at the UE 102 can be configured to decode the received on the PTC from with the base station 102.

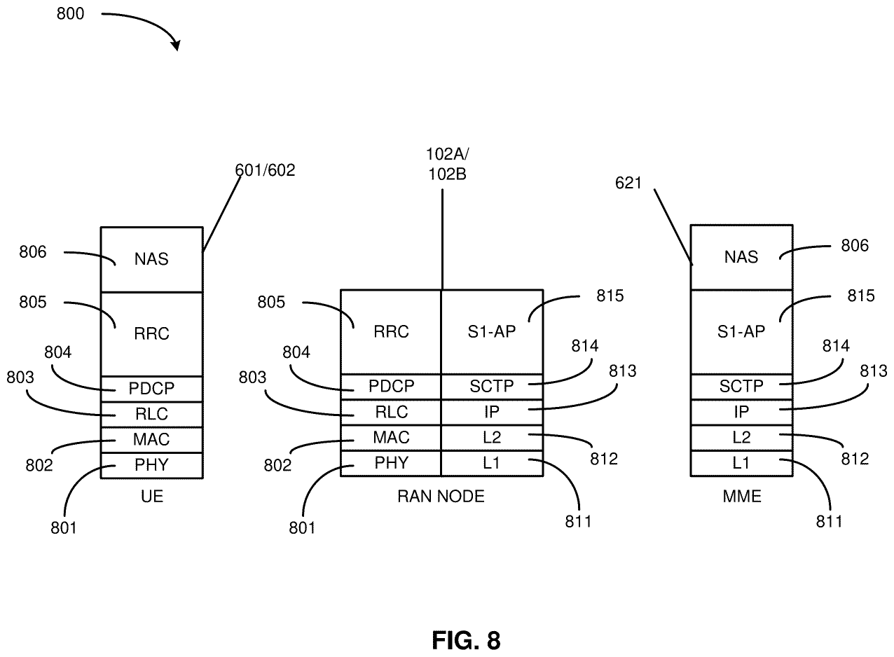

### FIG. 7: Block Diagram of an Interface of Baseband Circuitry

FIG. 7 illustrates example interfaces of baseband circuitry in accordance with some embodiments. It is noted that the baseband circuitry of FIG. 7 is merely one example of a possible circuitry, and that features of this disclosure may be implemented in any of various systems, as desired.

As discussed above, the baseband circuitry 604 of FIG. 6 may comprise processors 604A-604E and a memory 604G utilized by said processors. Each of the processors 604A-604E may include a memory interface, 704A-704E, respectively, to send/receive data to/from the memory 604G.

The baseband circuitry 604 may further include one or more interfaces to communicatively couple to other circuitries/devices, such as a memory interface 712 (e.g., an interface to send/receive data to/from memory external to the baseband circuitry 604), an application circuitry interface 714 (e.g., an interface to send/receive data to/from the application circuitry 602 of FIG. 6), an RF circuitry interface 716 (e.g., an interface to send/receive data to/from RF circuitry 606 of FIG. 6), a wireless hardware connectivity interface 718 (e.g., an interface to send/receive data to/from Near Field Communication (NFC) components, Bluetooth® components (e.g., Bluetooth® Low Energy), Wi-Fi® components, and other communication components), and a power management interface 720 (e.g., an interface to send/receive power or control signals to/from the PMC 612.

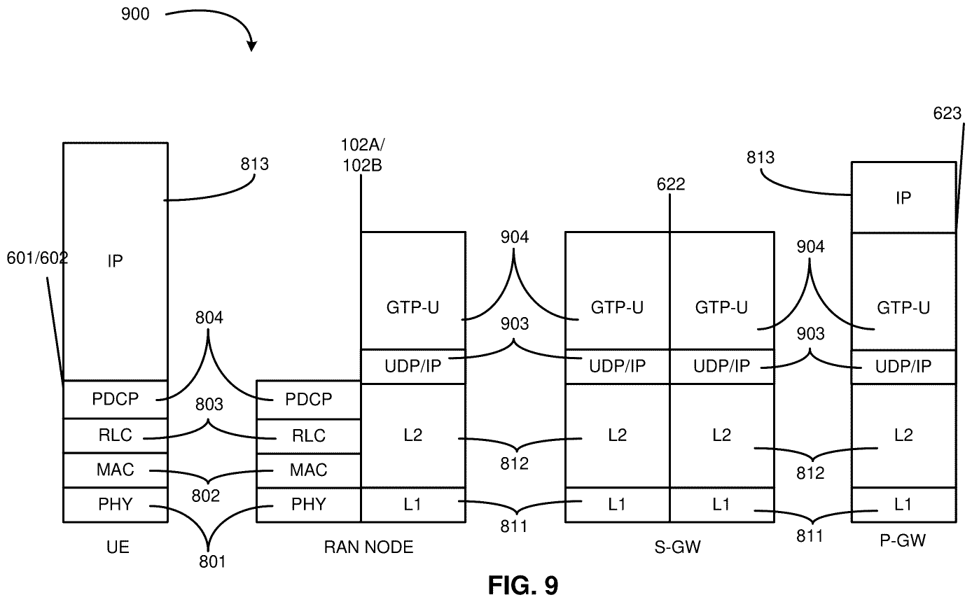

### FIG. 8: Control Plane Protocol Stack

FIG. 8 is an illustration of a control plane protocol stack in accordance with some embodiments. In this embodiment, a control plane 800 is shown as a communications protocol stack between the UE 106a (or alternatively, the UE 106b), the RAN node 102A (or alternatively, the RAN node 102B), and the mobility management entity (MME) 621.

The PHY layer 801 may transmit or receive information used by the MAC layer 802 over one or more air interfaces. The PHY layer 801 may further perform link adaptation or adaptive modulation and coding (AMC), power control, cell search (e.g., for initial synchronization and handover purposes), and other measurements used by higher layers, such as the RRC layer 805. The PHY layer 801 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 802 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 803 may operate in a plurality of modes of operation, including: Transparent Mode (TM), Unacknowledged Mode (UM), and Acknowledged Mode (AM). The RLC layer 803 may execute transfer of upper layer protocol data units (PDUs), error correction through automatic repeat request (ARQ) for AM data transfers, and concatenation, segmentation and reassembly of RLC SDUs for UM and AM data transfers. The RLC layer 803 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 804 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 805 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 106 and the RAN node 102A may utilize a Uu interface (e.g., an LTE-Uu interface) to exchange control plane data via a protocol stack comprising the PHY layer 801, the MAC layer 802, the RLC layer 803, the PDCP layer 804, and the RRC layer 805.

The non-access stratum (NAS) protocols 806 form the highest stratum of the control plane between the UE 601 and the MME 621. The NAS protocols 806 support the mobility of the UE 601 and the session management procedures to establish and maintain IP connectivity between the UE 601 and the P-GW 623.

The S1 Application Protocol (S1-AP) layer 815 may support the functions of the S1 interface and comprise Elementary Procedures (EPs). An EP is a unit of interaction between the RAN node 102A and the CN 1020. The S1-AP layer services may comprise two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The Stream Control Transmission Protocol (SCTP) layer (alternatively referred to as the SCTP/IP layer) 814 may ensure reliable delivery of signaling messages between the RAN node 102A and the MME 621 based, in part, on the IP protocol, supported by the IP layer 813. The L2 layer 812 and the L1 layer 811 may refer to communication links (e.g., wired or wireless) used by the RAN node and the MME to exchange information.

The RAN node 102A and the MME 621 may utilize an S1-MME interface to exchange control plane data via a protocol stack comprising the L1 layer 811, the L2 layer 812, the IP layer 813, the SCTP layer 814, and the S1-AP layer 815.

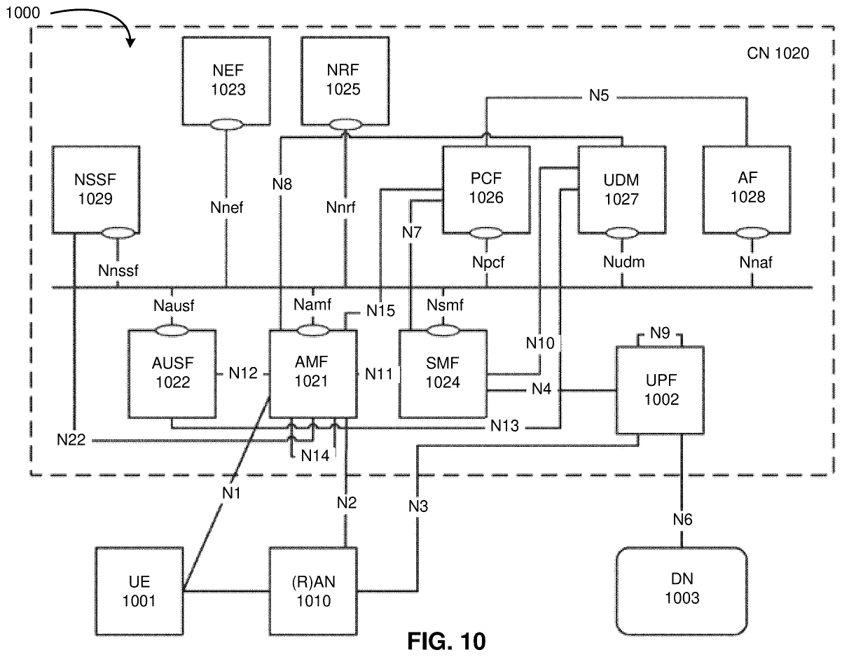

### FIG. 9: User Plane Protocol Stack

FIG. 9 is an illustration of an example of a user plane protocol stack in accordance with some embodiments. In this embodiment, a user plane 900 is shown as a communications protocol stack between the UE 106A (or alternatively, the UE 106B or 106N), the RAN node 102A (or alternatively, the RAN node 102B), the S-GW 622, and the P-GW 623. The user plane 900 may utilize at least some of the same protocol layers as the control plane 800. For example, the UE 601 and the RAN node 102A may utilize a Uu interface (e.g., an LTE-Uu interface) to exchange user plane data via a protocol stack comprising the PHY layer 801, the MAC layer 802, the RLC layer 803, the PDCP layer 804.

The General Packet Radio Service (GPRS) Tunneling Protocol for the user plane (GTP-U) layer 904 may be used for carrying user data within the GPRS core network and between the radio access network and the core network. The user data transported can be packets in any of IPv4, IPv6, or PPP formats, for example. The UDP and IP security (UDP/IP) layer 903 may provide checksums for data integrity, port numbers for addressing different functions at the source and destination, and encryption and authentication on the selected data flows. The RAN node 102A and the S-GW 622 may utilize an S1-U interface to exchange user plane data via a protocol stack comprising the L1 layer 811, the L2 layer 812, the UDP/IP layer 903, and the GTP-U layer 904. The S-GW 622 and the P-GW 623 may utilize an S5/S8a interface to exchange user plane data via a protocol stack comprising the L1 layer 811, the L2 layer 812, the UDP/IP layer 903, and the GTP-U layer 904. As discussed above with respect to FIG. 8, NAS protocols support the mobility of the UE 106 and the session management procedures to establish and maintain IP 813 connectivity between the UE 106 and the P-GW 623.

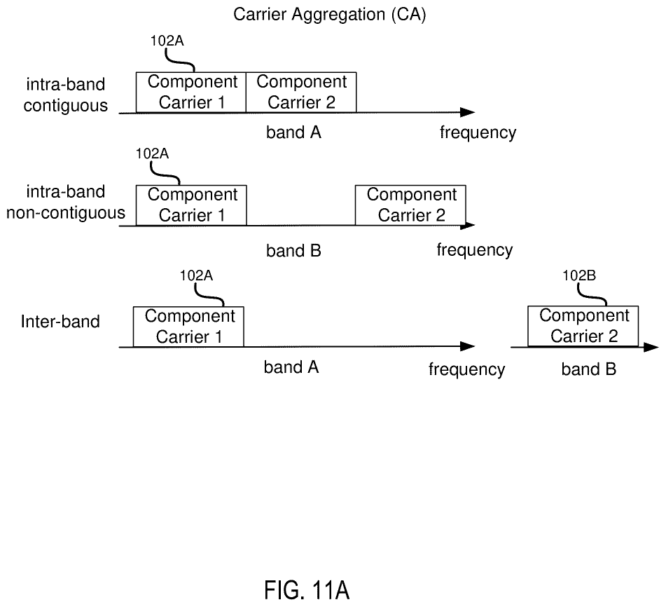

### FIG. 10: Core Network

FIG. 10 illustrates an example architecture of a system 1000 including a core network (CN) 1020 in accordance with various embodiments. The CN 1020 may be a core network for a 5G System (which may be referred to as a 5GC) or 6G system. The system 1000 is shown to include a UE 1001, which may be the same or similar to the UEs 106A, 106B, or 106N discussed previously; a (R)AN 1010, which may be the same or similar to the BSs 102A or 102N discussed previously; and a data network (DN) 1003, which may be, for example, operator services, Internet access, or 3rd party services; and a CN 1020. The CN 1020 can be the network 100 as discussed previously. The CN 1020 may include a number of network functions including an Authentication Server Function (AUSF) 1022; an Access and Mobility Management Function (AMF) 1021; a Session Management Function (SMF) 1024; a Network Exposure Function (NEF) 1023; a Policy Control Function (PCF) 1026; a Network Repository Function (NRF) 1025; a Unified Data Management (UDM) 1027; an Application Function (AF) 1028; a User Plane Function (UPF) 1002; and a Network Slice Selection Function (NSSF) 1029. These network functions may be implemented, in some cases, as virtualized software-based functions/services.

The UPF 1002 may act as an anchor point for intra-RAT and inter-RAT mobility, an external packet data unit (PDU) session point of interconnect to DN 1003, and a branching point to support mufti-homed PDU session. A PDU session is a logical connection between the UE and the DN. The UPF 1002 may also perform packet routing and forwarding, perform packet inspection, enforce the user plane part of policy rules, lawfully intercept packets (user plane (UP) collection), perform traffic usage reporting, perform quality of service (QoS) handling for a user plane (e.g., packet filtering, gating, UL/DL rate enforcement), perform Uplink Traffic verification (e.g., Service Data Flows (SDF) to QoS flow mapping), transport level packet marking in the uplink and downlink, and perform downlink packet buffering and downlink data notification triggering. UPF 1002 may include an uplink classifier to support routing traffic flows to a data network, The DN 1003 may represent various network operator services, Internet access, or third-party services. DN 1003 may include, or be similar to, application server 104 discussed previously. The UPF 1002 may interact with the SMF 1024 via an N4 reference point between the SMF 1024 and the UPF 1002.

The AUSF 1022 may store data for authentication of UE 1001 and handle authentication-related functionality, The AUSF 1022 may facilitate a common authentication framework for various access types. The AUSF 1022 may communicate with the AMF 1021 via an N12 reference point between the AMF 1021 and the AUSF 1022; and may communicate with the UDM 1027 via an N13 reference point between the UDM 1027 and the AUSF 1022. Additionally, the AUSF 1022 may exhibit an Nausf service-based interface.

The AMF 1021 may be responsible for registration management (e.g., for registering UE 1001, etc.), connection management, reachability management, mobility management, and lawful interception of AMF-related events, and access authentication and authorization. The AMF 1021 may be a termination point for an N11 reference point between the AMF 1021 and the SMF 1024. The AMF 1021 may provide transport for SM messages between the UE 1001 and the SMF 1024, and act as a transparent proxy for routing SM messages. AMF 1021 may also provide transport for Short Message Service (SMS) messages between UE 1001 and an SMSF (not shown by FIG. 10). AMF 1021 may act as a security anchor function (SEAF), which may include interaction with the AUSF 1022 and the UE 1001, receipt of an intermediate key that was established as a result of the UE 1001 authentication process. Where Universal Subscriber Identity Module (USIM) based authentication is used, the AMF 1021 may retrieve the security material from the AUSF 1022. AMF 1021 may also include a Security Context Management (SCM) function, which receives a key from the SEAF that it uses to derive access-network specific keys. Furthermore, AMF 1021 may be a termination point of a RAN control plane (CP) interface, which may include or be an N2 reference point between the (R)AN 1010 and the AMF 1021; and the AMF 1021 may be a termination point of NAS (N1) signaling and perform NAS ciphering and integrity protection.

AMF 1021 may also support NAS signaling with a UE 1001 over a non-3GPP Inter-Working Function (N3IWF) interface. The N3IWF may be used to provide access to untrusted entities. N3IWF may be a termination point for the N2 interface between the (R)AN 1010 and the AMF 1021 for the control plane and may be a termination point for the N3 reference point between the (R)AN 1010 and the UPF 1002 for the user plane. As such, the AMF 1021 may handle N2 signaling from the SMF 1024 and the AMF 1021 for PDU sessions and encapsulate/de encapsulate packets for IPSec and N3 tunneling, mark N3 user-plane packets in the uplink, and enforce QoS corresponding to N3 packet marking while considering QoS requirements associated with such marking received over N2. N3IWF may also relay uplink and downlink control plane non-access stratum (NAS) signaling between the UE 1001 and AMF 1021 via an N1 reference point between the UE 1001 and the AMF 1021, and relay uplink and downlink user-plane packets between the UE 1001 and UPF 1002. The N3IWF also provides mechanisms for internet protocol security (IPsec) tunnel establishment with the UE 1001. The AMF 1021 may exhibit an Namf service based interface and may be a termination point for an N14 reference point between two AMFs 1021 and an N17 reference point between the AMF 1021 and a 5G Equipment Identity Register (5G-EIR) (not shown by FIG. 10).

The UE 1001 may need to register with the AMF 1021 in order to receive network services. Registration Management (RM) is used to register or deregister the UE 1001 with the network (e.g., AMF 1021), and establish a UE context in the network (e.g., AMF 1021). The UE 1001 may operate in an RM-REGISTERED state or an RM-DEREGISTERED state. In the RM-DEREGISTERED state, the UE 1001 is not registered with the network, and the UE context in AMF 1021 holds no valid location or routing information for the UE 1001 so the UE 1001 is not reachable by the AMF 1021. In the RM REGISTERED state, the UE 1001 is registered with the network, and the UE context in AMF 1021 may hold a valid location or routing information for the UE 1001 so the UE 1001 is reachable by the AMF 1021. In the RM-REGISTERED state, the UE 1001 may perform mobility registration update procedures, perform periodic registration update procedures triggered by expiration of the periodic update timer (e.g., to notify the network that the UE 1001 is still active), and perform a Registration Update procedure to update UE capability information or to re-negotiate protocol parameters with the network, among others.

The AMF 1021 may store one or more RM contexts for the UE 1001, where each RM context is associated with a specific access to the network. The RM context may be a data structure, database object, etc. that indicates or stores, inter glia, a registration state per access type and the periodic update timer. The AMF 1021 may also store a 5GC mobility management (MM) context that may be the same or similar to the evolved packet services (EPS) Mobility Management (E)MM context discussed previously. In various embodiments, the AMF 1021 may store a CE mode B Restriction parameter of the UE 1001 in an associated MM context or registration management (RM) context. The AMF 1021 may also derive the value, when needed, from the UE's usage setting parameter already stored in the UE context (and/or MM/RM context).

Connection Management (CM) may be used to establish and release a signaling connection between the UE 1001 and the AMF 1021 over the N1 interface. The signaling connection is used to enable NAS signaling exchange between the UE 1001 and the CN 1020 and comprises both the signaling connection between the UE and the AN (e.g., RRC connection or UE-N3IWF connection for non-3GPP access) and the N2 connection for the UE 1001 between the AN (e.g., AN 1010) and the AMF 1021. The UE 1001 may operate in one of two CM states, CM-IDLE mode or CM-CONNECTED mode. When the UE 1001 is operating in the CM-IDLE state/mode, the UE 1001 may have no NAS signaling connection established with the AMF 1021 over the N1 interface, and there may be (R)AN 1010 signaling connection (e.g., N2 and/or N3 connections) for the UE 1001. When the UE 1001 is operating in the CM-CONNECTED state/mode, the UE 1001 may have an established NAS signaling connection with the AMF 1021 over the NI interface, and there may be a (R)AN 1010 signaling connection (e.g., N2 and/or N3 connections) for the UE 1001. Establishment of an N2 connection between the (R)AN 1010 and the AMF 1021 may cause the UE 1001 to transition from CM-IDLE mode to CM-CONNECTED mode, and the UE 1001 may transition from the CM-CONNECTED mode to the CM-IDLE mode when N2 signaling between the (R)AN 1010 and the AMF 1021 is released.

The SMF 1024 may be responsible for session management (SM) session establishment, modify and release, including tunnel maintain between UPF and AN node); UE IP address allocation and management (including optional authorization); selection and control of UP function; configuring traffic steering at UPF to route traffic to proper destination; termination of interfaces toward policy control functions; controlling part of policy enforcement and QoS; lawful intercept (for SM events and interface to LI system); termination of SM parts of NAS messages; downlink data notification; initiating AN specific SM information, sent via AMF over N2 to AN; and determining SSC mode of a session. SM may refer to management of a PDU session, and a PDU session or “session” may refer to a PDU connectivity service that provides or enables the exchange of PDUs between a UE 1001 and a data network (DN) 1003 identified by a Data Network Name (DNN). PDU sessions may be established upon UE 1001 request, modified upon UE 1001 and CN 1020 request, and released upon UE 1001 and CN 1020 request using NAS SM signaling exchanged over the N1 reference point between the UE 1001 and the SMF 1024. Upon request from an application server, the CN 1020 may trigger a specific application in the UE 1001. In response to receipt of the trigger message, the UE 1001 may pass the trigger message (or relevant parts/information of the trigger message) to one or more identified applications in the UE 1001. The identified application(s) in the UE 1001 may establish a PDU session to a specific data network name (DNN). The SMF 1024 may check whether the UE 1001 requests are compliant with user subscription information associated with the UE 1001. In this regard, the SMF 1024 may retrieve and/or request to receive update notifications on SMF 1024 level subscription data from the UDM 1027.

The SMF 1024 may include the following roaming functionality: handling local enforcement to apply QoS SLAB virtual Public Land Mobile Network (VPLMN); charging data collection and charging interface (VPLMN); lawful intercept (in VPLMN for SM events and interface to LI system); and support for interaction with external DN for transport of signaling for PDU session authorization/authentication by external DN. An N16 reference point between two SMFs 1024 may be included in the system 1000, which may be between another SMF 1024 in a visited network and the SMF 1024 in the home network in roaming scenarios. Additionally, the SMF 1024 may exhibit the Nsmf service-based interface.

The NEF 1023 may provide means for securely exposing the services and capabilities provided by 3GPP network functions for third party, internal exposure/re-exposure, Application Functions (e.g., AF 1028), edge computing or fog computing systems, etc. In such embodiments, the NEF 1023 may authenticate, authorize, and/or throttle the AFS. NEF 1023 may also translate information exchanged with the AF 1028 and information exchanged with internal network functions. For example, the NEF 1023 may translate between an AF-Service-Identifier and an internal SCC information. NEF 1023 may also receive information from other network functions (NFs) based on exposed capabilities of other network functions. This information may be stored at the NEF 1023 as structured data, or at a data storage NF using standardized interfaces. The stored information can then be re-exposed by the NEF 1023 to other NFs and AFs, and/or used for other purposes such as analytics. Additionally, the NEF 1023 may exhibit an Nnef service-based interface.

The NRF 1025 may support service discovery functions, receive NF discovery requests from NF instances, and provide the information of the discovered NF instances to the NF instances. NRF 1025 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1025 may exhibit the Nnrf service-based interface.

The PCF 1026 may provide policy rules to control plane function(s) to enforce them and may also support unified policy framework to govern network behavior, The PCF 1026 may also implement a front end (FE) to access subscription information relevant for policy decisions in a UDR of the UDM 1027. The PCF 1026 may communicate with the AMF 1021 via an N15 reference point between the PCF 1026 and the AMF 1021, which may include a PCF 1026 in a visited network and the AMF 1021 in case of roaming scenarios. The PCF 1026 may communicate with the AF 1028 via an NS reference point between the PCF 1026 and the AF 1028; and with the SMF 1024 via an N7 reference point between the PCF 1026 and the SMF 1024, The system 1000 and/or CN 1020 may also include an N24 reference point between the PCF 1026 (in the home network) and a PCF 1026 in a visited network, Additionally, the PCF 1026 may exhibit an Npcf service-based interface.

The UDM 1027 may handle subscription-related information to support the network entities'handling of communication sessions and may store subscription data of UE 1001. For example, subscription data may be communicated between the UDM 1027 and the AMF 1021 via an NS reference point between the UDM 1027 and the AMF. The UDM 1027 may include two parts, an application FE and a UDR (the FE and UDR are not shown by FIG. 10). The UDR may store subscription data and policy data for the UDM 1027 and the PCF 1026, and/or structured data for exposure and application data (including PFDs for application detection, application request information for multiple UEs 1001) for the NEF 1023. The Nadr service-based interface may be exhibited by the UDR to allow the UDM 1027, PCF 1026, and NEF 1023 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. The UDR may interact with the SMF 1024 via an NI0 reference point between the UDM 1027 and the SMF 1024. UDM 1027 may also support SMS management, wherein an SMS-FE implements the similar application logic as discussed previously. Additionally, the UDM 1027 may exhibit the Nudm service based interface.

The AF 1028 may provide application influence on traffic routing, provide access to the NCE, and interact with the policy framework for policy control. The NCE may be a mechanism that allows the CN 1020 and AF 1028 to provide information to each other via NEF 1023, which may be used for edge computing implementations. In such implementations, the network operator and third party services may be hosted close to the UE 1001 access point of attachment to achieve an efficient service delivery through the reduced end-to-end latency and load on the transport network. For edge computing implementations, the 5GC may select a UPF 1002 close to the UE 1001 and execute traffic steering from the UPF 1002 to DN 1003 via the N6 interface. This may be based on the UE subscription data, UE location, and information provided by the AF 1028. In this way, the AF 1028 may influence UPF (re)selection and traffic routing. Based on operator deployment, when AF 1028 is considered to be a trusted entity, the network operator may permit AF 1028 to interact directly with relevant NFs. Additionally, the AF 1028 may exhibit an Naf service-based interface.

The NSSF 1029 may select a set of network slice instances serving the UE 1001. The NSSF 1029 may also determine allowed Network Slice Selection Assistance Information (NSSAI) and the mapping to the subscribed single NSSAI (S-NSSAI) is, if needed. The NSSF 1029 may also determine the AMF set to be used to serve the UE 1001, or a list of candidate AMF(s) 1021 based on a suitable configuration and possibly by querying the NRF 1025. The selection of a set of network slice instances for the UE 1001 may be triggered by the AMF 1021 with which the UE 1001 is registered by interacting with the NSSF 1029, which may lead to a change of AMF 1021. The NSSF 1029 may interact with the AMF 1021 via an N22 reference point between AMF 1021 and NSSF 1029; and may communicate with another NSSF 1029 in a visited network via an N31 reference point (not shown by FIG. 10). Additionally, the NSSF 1029 may exhibit an Nnssf service-based interface.

As discussed previously, the CN 1020 may include a short message service function (SMSF), which may be responsible for SMS subscription checking and verification, and relaying SM messages to/from the UE 1001 to/from other entities, such as an SMS-GMSC/IWMSC/SMS-router. The SMS may also interact with AMF 1021 and UDM 1027 for a notification procedure that the UE 1001 is available for SMS transfer (e.g., set a UE not reachable flag, and notifying UDM 1027 when UE 1001 is available for SMS).

The CN 1020 may also include other elements that are not shown by FIG. 10, such as a Data Storage system/architecture, a 5G-EIR, a Security Edge Protection Proxy (SEPP), and the like. The Data Storage system may include a Structured Data Storage Network Function (SDSF), air Unstructured Data Storage Function (UDSF), and/or the like. Any network function (NF) may store and retrieve unstructured data into/from the UDSF (e.g., UE contexts), via N18 reference point between any NF and the UDSF (not shown by FIG. 10), Individual NFs may share a UDSF for storing their respective unstructured data or individual NFs may each have their own UDSF located at or near the individual NFs. Addition ally, the UDSF may exhibit an Nudsf service-based interface (not shown by FIG. 10). The 5G-EIR may be an NF that checks the status of permanent equipment identifier (PEI) for determining whether particular equipment/entities are blacklisted from the network; and the SEPP may be a non-transparent proxy that performs topology hiding, message filtering, and policing on inter-PLMN control plane interfaces.

Additionally, there may be many more reference points and/or service-based interfaces between the NF services in the NFs; however, these interfaces and reference points have been omitted from FIG. 10 for clarity. In one example, the CN 1020 may include an Nx interface, which is an inter-CN interface between a mobility management entity (MME) and the AMF 1021 in order to enable interworking between CN 1020 and a CN in a 4G or 5G system and a 6G system. Other example interfaces/reference points may include an N5G-EIR service-based interface exhibited by a 5G-EIR, an N27 reference point between the NRF in the visited network and the NRF in the home network; and an N31 reference point between the NSSF in the visited network and the NSSF in the home network.

### Phase Noise in OFDM Systems

With each new generation of wireless communication, more bandwidth has been provided to enable faster communication. 5G-NR was no exception. In 3GPP 4G, the maximum available bandwidth of a signal was 20 megahertz (MHz). With the introduction of 3GPP 5G NR, the broadest bandwidth was increased to 400 MHz per carrier. This allows the transmission of very high data rates to allow large files to be communicated with 5G in short periods of time.

However, the use of broad bandwidth does not come without a cost. As bandwidth increases, the amount of power and signal processing at a UE also increases. With the advent of very broad bandwidth in 5G-NR, it could result in could result in power drain and processing levels at a UE that would rapidly drain a typical UE's battery.

One cause of power drain due to high processing levels at a UE is in the reception and demodulation of signals with excessive amounts of phase noise. Phase noise is the noise arising from the rapid, short term, random phase fluctuations that occur in a signal. In signal processing, phase noise is the frequency-domain representation of random fluctuations in the phase of a waveform, corresponding to time-domain deviations from perfect periodicity (jitter). Phase noise is caused by the inherent randomness of the analog local oscillator's (LO) output frequency that is used in mixing or up/down conversion of the signal between baseband and the radio frequency (RF) band used for transmission.

Third generation partnership project (3GPP) communication uses orthogonal frequency division multiplexing (OFDM). OFDM is a digital transmission technique that uses multiple carrier frequencies, referred to as subcarriers, to encode digital data.

OFDM systems offers high data throughput with multiple input multiple output (MIMO) spatial multiplexing, higher order modulation, and carrier aggregation (CA). In 3GPP 5G, and the upcoming 6G standard, some of the higher bands in frequency range 1(FR1), and the bands in frequency range 2(FR2) and FR3 are used for high frequency, broadband communication. Phase noise limits higher order modulation when the carrier frequency is high (e.g. sub terahertz (THz).

There are two effects that occur when phase noise is present in an OFDM system: rotation of all demodulated subcarriers of an OFDM symbol by a common angle, called common phase error (CPE) and the occurrence of the intercarrier interference (ICI). The CPE results from the direct current (DC) value of the phase noise and the ICI comes from the deviations of the phase noise during one OFDM symbol from its DC value. ICI caused by phase noise refers to the unwanted signal leakage between different subcarriers, occurring when the oscillator generating the carrier signal experiences phase fluctuations, essentially causing the signal on one subcarrier to bleed into the adjacent subcarriers, degrading overall system performance.

In order to minimize the effects of phase noise in an OFDM system, a phase tracking reference signal (PTRS) was introduced. The PTRS can be used to track the phase of the local oscillator (LO) at the transmitter and receiver. In 5G communications, PTRS are used in both the uplink new radio-physical uplink shared channel (NR-PUSCH) and the downlink NR-physical downlink shared channel (NR-PDSCH). The system can configure PTRS depending on the quality of the Los, the carrier frequency, subcarrier spacing (SCS), and the modulation and coding scheme (MCS) used to communicate between a user equipment (UE) and base station (BS).

In 5G-NR OFDM communication, the PTRS is placed in the frequency domain, and is used to estimate symbol level CPE. ICI can be estimated using a de-ICI filter or using an iterative method. However, these methods put an increased burden on receiver complexity.

Another transmission scheme that can be used for 5G-NR communication is Discrete Fourier Transform-Spread-Orthogonal Frequency Division Multiplexing (DFT-s-OFDM), which is a single carrier-based transmission scheme that is utilized in the uplink of LTE and 5G-NR wireless systems. With 5G-NR DFT-s-OFDM, the PTRS is placed in the time domain. Phase noise can be estimated with a time granularity that is finer than one OFDM symbol. However, DFT-s-OFDM is not considered for high throughput in 5G-NR. It is mainly targeted for the use of coverage extension of single layer transmission with lower signal to noise ratio (SNR) and MCS. For a single carrier waveform, phase noise tracking is relatively simple and can be made finer in granularity. For example, a unique word phase tracking is used in single carrier waveforms of the institute of electrical and electronic engineers (IEEE) 802.11ay and 802.15.3d specifications.

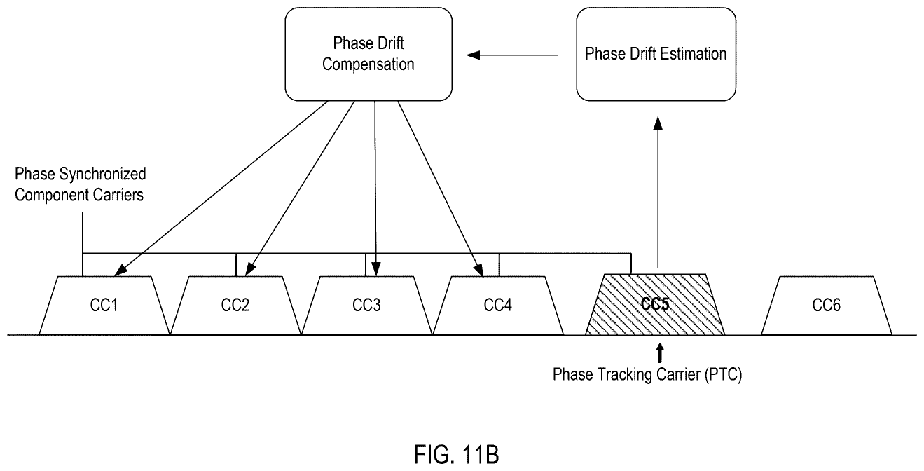

### FIGS. 11A, 11B: Carrier Aggregation With Phase Tracking Carrier

In wireless communications, baseband data is typically modulated using a local oscillator (LO) of a selected frequency. The LO signal with the modulated data is then upconverted to a carrier RF signal. The carrier RF signal is defined with a center frequency and a bandwidth. The radio frequency spectrum has been divided up into different bands by governments and industry. Governments typically control and allocated which RF bands are used for different types of communication. Separate bands are used for military communication, industrial communication, satellite communication, civilian communication, and so forth. Bands used for cellular communication, such as 3GPP bands, are typically assigned, leased, or purchased by private companies, also referred to as carriers, such as AT&T and Verizon in the United States. Other countries may also lease bands to private companies or otherwise assign the bands for use.

The bands used in cellular communication can be of different sizes. In 3GPP 4G communications, channels can have a bandwidth of 1.4, 3, 5, 10, 15 or 20 MHz. In 5G, the maximum bandwidth was increased to 100 MHz in FR1, and 400 MHz in FR2. The center frequency of the channels is designated in the 3GPP specification. For example, 3GPP communication bands are designated in 3GPP Technical Specification (TS) 36.104 for 4G and 38.104 for 5G-NR. One non-limiting example of the specifications is 3GPP TS 36.104 V 18.5.0 (April 2024) and 3GPP 38.104 V 18.7.0 (September 2024). Similarly, bands will be allocated for 3GPP 6G and other future specifications. The bands owned by cellular carriers are often located all over the radio frequency spectrum and have different bandwidths. Each of the bands can have one or more channels.

To provide even greater bandwidth than is available with a single channel, the concept of carrier aggregation was disclosed in 3GPP 4G. In carrier aggregation, different carriers (e.g. bands) can be used simultaneously by a user equipment. Each carrier used in carrier aggregation is referred to as a component carrier (CC). In 4G communication, up to 5 different 20 MHz component carriers (bands) can be used by a UE to provide a 100 MHz band. In 3GPP NR-5 G, the maximum number of component carriers was increased to 16 CCs for UL and 16 CCs for DL. This provides a maximum bandwidth of 6.4 GHz in UL and 6.4 GHz in DL in FR2.

FIG. 11A illustrates an example block diagram showing inter-band and intra-band carrier aggregation (CA), in accordance with some embodiments. In intra-band carrier aggregation, the component carriers (CC) are within the same band, such as Band A or Band B in this example. The intra-band CCs can be contiguous or non-contiguous. While two CCs are shown in FIG. 11A, this is not intended to be limiting. In 4G communication, there can be up to 5 CCs. In 5G communication, there can be up to 16 CCs. In future 3GPP releases, additional CCs may be used. The contiguous CCs can be different channels within the same band. The intra-band CCs may be transmitted by a single base station, such as 102A. Alternatively, multiple different base stations, such as 102A, 102B, may transmit the intra-band CCs. Inter-band CCS can also be transmitted, as shown in FIG. 11A. Inter-band CCs are located in different bands, such as Band A and Band B. The inter-band CCs may be transmitted by different base stations.

The different component carriers may be contiguous in frequency, or non-contiguous. The component carriers can be channels that are in the same band (intra-band), or in a different band (inter-band). In a typical carrier aggregation scenario, each CC may have a different amount of phase noise, resulting in different CPE and ICI for each CC. This can create added complexity at the receiver to receive the different signals in the CCs used in CA that have different CPE and ICI.

FIG. 11B illustrates an example block diagram showing 5 component carriers (CC1-CC5), in accordance with some embodiments. Each CC may be adjacent, non-adjacent, inter-band, or intra-band. Each CC may have a same channel bandwidth, or a different channel bandwidth. In this example, a new type of component carrier is disclosed. One of the component carriers can be designated as a phase tracking carrier (PTC). In this example, CC5 is disclosed as a PTC. A PTC can be an anchor carrier that is designed specifically for phase tracking in a carrier aggregation (CA) scenario.

Phase synchronized component carriers are component carriers that have the same or correlated frequency and/or phase shift. Phase drift estimated in one CC can be applied to compensate phase drift in other CCs that are phase synchronized. The PTC illustrated in FIG. 11B can be used to estimate phase or frequency drift. Phase drift compensation based on the PTC can then be applied to all of the CCs used for CA that are phase synchronized with the PTC. In this example, CC1-CC4 are phase synchronized CCs that are synchronized with the PTC of CC5. Accordingly, the phase drift compensation estimated from the PTC of CC5 can be applied to the signals communicated via CC1-CC4. This can enable peak throughput using CA and simplify UR receiver (Rx) processing for phase drift compensation.

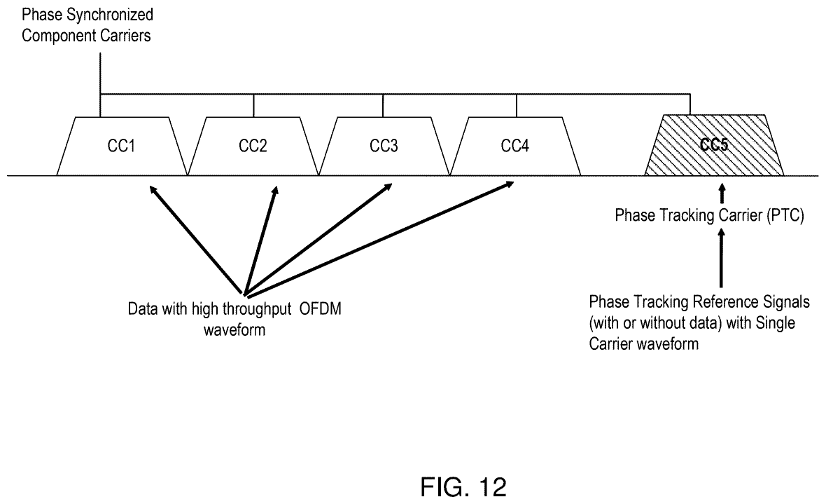

### FIG. 12: Phase Tracking Carrier Design—Waveform Design

In some embodiments, 5G-NR waveforms used for reference signals can be reused for signals, such as reference signals, communicated via the phase tracking carrier. For example, using OFDM to transmit data and PT-RS, or DFT-s-OFDM with time-domain for data plus PT-RS, or a primary synchronization signal (PSS) and secondary synchronization signal (SSS) in a synchronization signal/physical broadcast channel block (SSB).

However, phase noise is a time-domain impairment. Accordingly, for waveform design for reference signals communicated via the PTC, a single carrier waveform can be used to provide a better quality of phase noise compensation. In addition, a single carrier waveform can reduce the Rx complexity for the phase noise estimation and compensation for receiver processing at the baseband processor 604C, 604D. In some embodiments, every CC used for CA can carry different waveforms. Therefore, it is proposed to use a single carrier waveform option for signals communicated via the PTC. For example, a single carrier waveform with a periodic unique word sequence (with data) can be used. Another example is a single carrier reference signal, such as a time-domain Zad-off Chu sequence, or modulated (e.g. quadrature phase shift keying (QPSK)) sequences, such as a modulated Golay sequence, a Gold sequence, or an m-sequence.

In some embodiments, for ICI, the PTC can be designed with a single carrier based waveform in order to enable a low complexity receiver processing for ICI mitigation. For CPE, the PTC can be scheduled as a CP-OFDM with PTRS, where the phase synchronized requirement can also be restricted to being synchronized in a common phase, such as a low frequency part of the phase noise.

FIG. 12 illustrates an example block diagram showing CA with phase synchronized component carriers (CC1-CC4), used to communicate data with a high throughput OFDM waveform, and CC5 configured as a PTC used to transmit phase tracing reference signals (with or without data) using a single carrier waveform, in accordance with some embodiments.

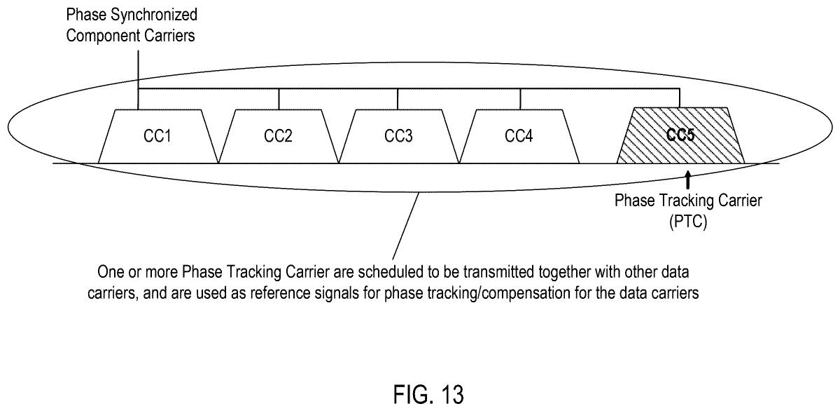

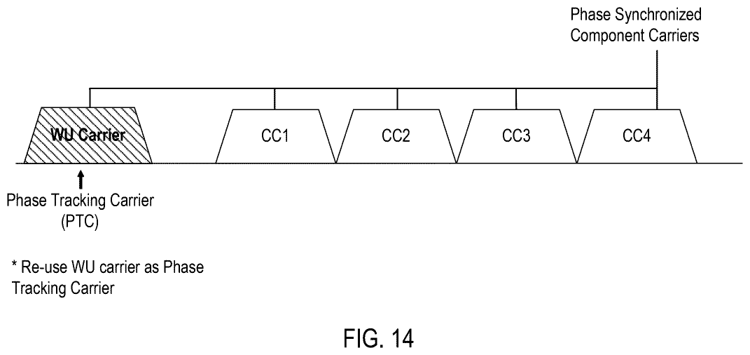

### FIGS. 13 and 14: Scheduling Design

The use of a phase tracking carrier can increase throughput when using carrier aggregation. The network 100 can use the PTC to schedule RS carried by the PTC. The PTC may also be scheduled to carry data. In some embodiments, when there are data transmissions in other component carriers, in the case of CA, the base station 102 can schedule the PTC in addition to the usual data carriers in other CCs.

The PTC is configured to carry reference signals for phase tracking of other data component carriers for data demodulation. The scheduling of the reference signals can be through a control channel, such as the PDCCH, indicating a particular component carrier to be the PTC, and indicating the CC's bandwidth, waveform, and so forth. The scheduling decision can depend on the network's 100 implementation, but some information from the UE 106 can be used to help the network's 100 scheduling decision.

FIG. 13 illustrates an example block diagram showing one or more phase tracking carriers (PTC) that are configured to carry scheduled reference signals together with reference signals and data in other component carriers used to communicate data and control information. In this example, CC5 is a PTC. The PTC RS can be used for phase tracking and compensation for the data component carriers CC1 to CC4. CC1-CC4 are phase synchronized component carriers.

FIG. 14 illustrates an example block diagram showing phase synchronized component carriers with a phase tracking component carrier (PTC) that is a wakeup (WU) carrier. A component carrier designated as a WU carrier can be re-used and scheduled as a phase tracking carrier whenever there are phase synchronized CCs with respect to the WU carrier(s).

In one example, the CCs used for CA can comprise a low frequency WU carrier, together with component carriers configured as high frequency data component carriers. The signals carried by the data CCs can have a carrier frequency that is an integer multiple of the carrier frequency of the WU carrier, and can be assumed to be phase synchronized through a highly correlated frequency multiplier circuit architecture at transmission and reception.

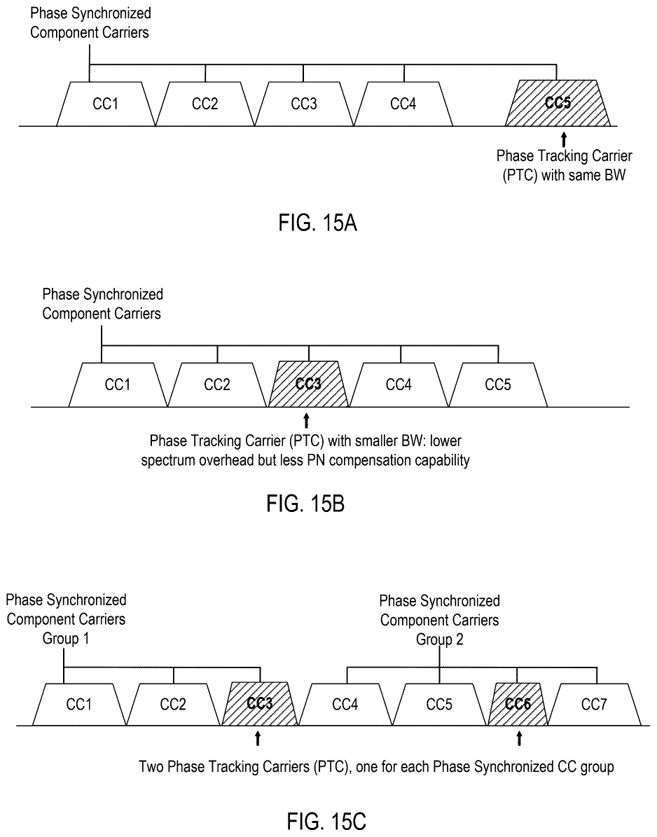

### FIGS. 15A-15C: Configuration Design for Single Carrier PTC

In some embodiments, when the PTC is configured to carry a single carrier waveform, the bandwidth of the PTC determines the bandwidth of the phase noise compensation. The bandwidth of the PTC can be selected to conform to the numerologies in a communication system. For example, for 3GPP 5G-NR and beyond, the bandwidth can be chosen to be any of the channel bandwidths of 50, 100, 200, 400, 800 MHz, 1600 MHz, 3200 MHz, 6400 MHz, and so forth. FIG. 15A illustrates an example block diagram showing a PTC (CC5) with a same bandwidth as the data CCs (CC1-CC4). CC1-CC4 are phase synchronized carrier components with CC5.

In some embodiments, the bandwidth of the PTC can be different from the bandwidth of the data component carriers. In particular, the bandwidth of the PTC can be selected by considering the bandwidth and MCS of the data CCs, as well as a UE's phase noise power spectral density (PSD). FIG. 15B illustrates an example block diagram showing a PTC (CC3) with a smaller BW than the data CCs (CC1, CC2, CC4, CC5) that can be phase synchronized with the PTC. The smaller bandwidth results in lower spectrum overhead but less phase noise compensation capability.

To support a higher MCS by mitigating the ICI effect, a higher frequency portion of the phase noise needs to be compensated, hence a higher bandwidth of the Phase Tracking Carrier is needed. A higher bandwidth of a PTC helps to reduce phase noise with a higher frequency, which is the source of ICI. PTC with a higher bandwidth is better to be scheduled with a single carrier based waveform or completely with reference signals without data. The estimated time division (TD) phase noise by the phase tracking reference signal (PTRS) from the PTC can then be used to compensate all CCs phase noise in the time domain.

For CPE, the PTC scheduled with higher subcarrier spacing (SCS) (not BW but SCS) will have a better capability to mitigate the CPE in other data CCs used for carrier aggregation. That is, if the SCS of the data CC is smaller or equal to the SCS of the PTC, then the CPE estimated by the PTRS in the PTC can be applied to other data CCs. If SCS of the PTC and the data CCs are equal, the CPE can be directly applied. If the data CC's SCS is smaller than the SCS of the PTC, e.g. 2× smaller, than an averaged CPE of the PTC over, e.g. 2 consecutive OFDM symbols which has the same time duration as 1 OFDM symbol in the data CC of 2× smaller SCS can be used.

However, if the SCS of the data CC is larger than the SCS of the PTC, then the CPE estimated by the PTRS in the PTC can still be applied to the data CC. In such a case, due to a lower granularity of the CPE in the data CC, the CPE cannot be compensated per OFDM symbol in the data CC, but can only compensate the CPE per two OFDM symbols in the data CC.

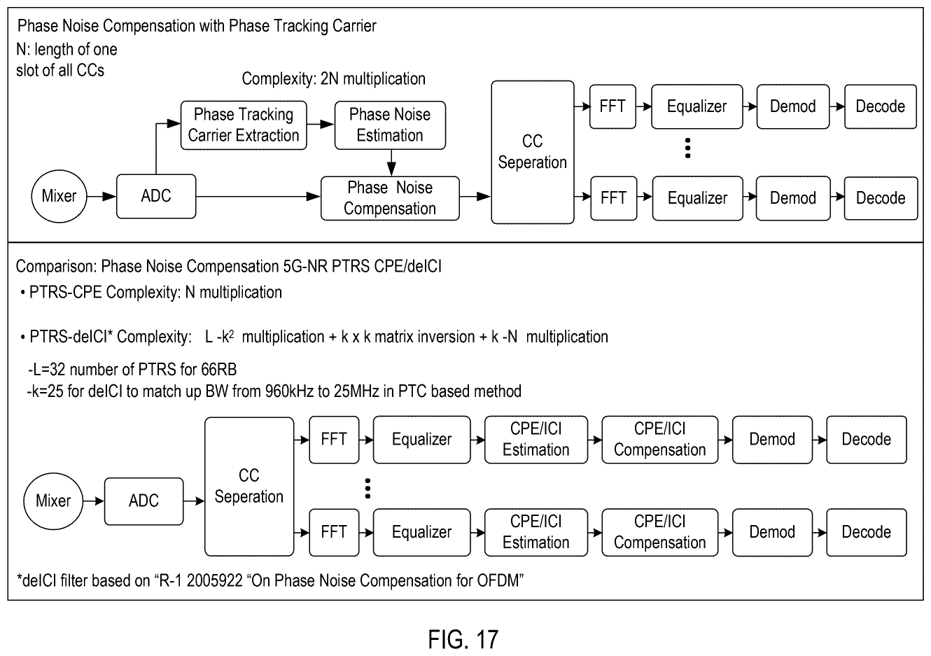

FIG. 15C illustrates an example block diagram showing two PTCs (CC3, CC6). CC3 is phase synchronized with CC Group 1, comprising CC1 and CC2. CC6 is phase synchronized with CC Group 2, comprising CC4, CC5 and CC7. The CA in the example of FIG. 17 includes 5 data CCs and 2 PTC CCs in two PTC groups. A receiver can be configured to use the PT-RS from the PTC CC3 to perform phase noise compensation when receiving data on the signals carried by CC1 and CC2. Similarly, the receiver can be configured to use the PT-RS from the PTC of CC6 to perform phase noise compensation when receiving data on the signals carried by CC4, CC5, and CC7.

In some embodiments, the frequency locations of the PTC(s) can be configured by the network 100 to maximize the phase noise compensation capability based on the frequency locations of the phase synchronized CCs.

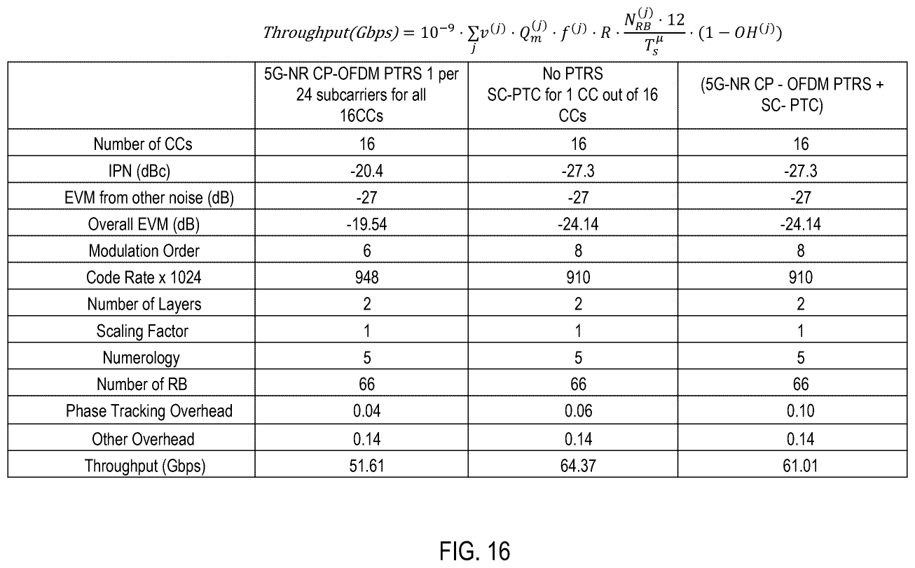

### FIGS. 16-17: Carrier Aggregation With PTC Benefits

FIG. 16 illustrates an example table showing the benefits of carrier aggregation with a phase tracking carrier, in accordance with some embodiments. In this example, there are 16 CCs. The CCs are intra-band and phase synchronized. The Fast Fourier Transform (FFT) size is 1024, with an SCS of 480 kHz in FR2. The bandwidth of each CC is 400 MHz, with an aggregated BW for all 16 CCs of 6.4 gigahertz (GHz). The phase tracking overhead for 5G-NR PTRS is 1 PTRS per 2 RB per OFDM symbols, and 1 PTRS per 24 subcarriers. For PTC, there is 1 CC designated as the PTC out of 16 CCs. The modulation order is selected to the maximum MCS that achieves <10% block error rate (BLER) with respect to the average white gaussian noise (AWGN) SNR.

The throughput, in gigabits per second

$$( Gbps ) = 1 {0}^{- 9} \cdot {\sum }_{j} {v}^{( j )} \cdot {Q}_{m}^{( j )} \cdot {f}^{( j )} \cdot R \cdot \frac{{N}_{RB}^{( j )} \cdot 12}{{T}_{s}^{μ}} \cdot$$

(1−OH^{(j)}, is shown at the bottom of the table for three different types of transmissions, where v is a max MIMO rank, Qm is a max modulation order, f is a scaling factor by UE capability, R is a max code rate, N_RB is a number of resource blocks (RBs), Ts is an OFDM symbol duration, and OH is an additional overhead (e.g. control channel and reference signals).

The first transmission, in the first column in FIG. 16, is the 5G-NR cyclic prefix (CP)-OFDM PTRS 1 per 24 subcarriers for all 16 CCs. The integrated phase noise (IPN) is provided in dBc, a measurement of noise that is expressed in decibels relative to the carrier (dBc/Hz). The overall error vector magnitude (EVM) is shown in decibels (dB). In addition, the modulation order, code rate (×1024), number of layers, scaling factor, numerology, number of resource blocks (RB), phase tracking overhead, and other overhead is shown. The throughput for the transmission using PTRS is 51.61 Gbps.

The second column in FIG. 16 shows a transmission with no PTRS, with a single carrier phase tracking carrier signal, with 1 CC of the 16 CCs designated as the PTC. The other 15 CCs are phase synchronized. As can be seen in the table of FIG. 16, the IPN is −27.3, 6.9 dB lower than in the PTRS measurement. In addition, the overall EVM is 4.6 dB lower than the PTRS measurement. However, the phase tracking overhead is 6%, relative to the phase tracking overhead of 4% with the PTRS measurement. The throughput in the second column is 64.37 Gbps, a significant improvement over the throughput using PTRS.

The third column in FIG. 16 shows a transmission using both 5G-NR CP-OFDM PTRS plus the SC-PTC. In this example, the measurement values are the same as in the second column, with an additional overhead of 10% (0.10), resulting in a throughput of 61.01 Gbps. Accordingly, there is a tradeoff of 2-6% overhead with ~7 dB IPN improvement, resulting in 4-5 dB overall EVM improvement and an increase of 1.2-1.25× throughput gain. In order to make sure CPE is cancelled (to avoid non-Gaussian noise), PTRS may still be configured in the OFDM data CCs.

FIG. 17 provides an example block diagram showing a comparison between phase noise compensation using 5G-NR PTRS and a CPE de-ICI filter, and phase noise compensation with a PTC. As can be seen, when using phase noise compensation with a PTC, the phase noise compensation can be performed prior to component carrier separation. Phase noise compensation using 5G-NR PTRS involves calculating and compensating for phase noise in each separate CC. Accordingly, there is a significant savings in receiver complexity when using PTC for phase noise cancelation relative to PTRS.

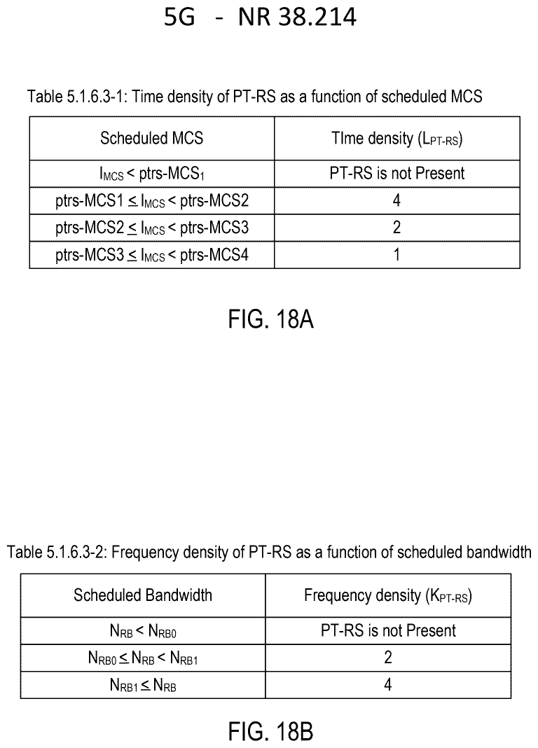

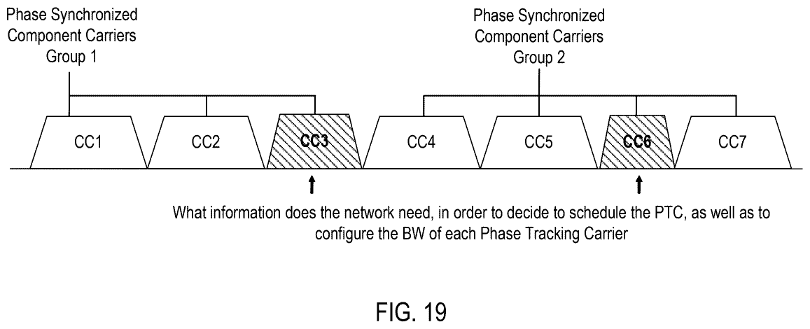

### FIGS. 18A-19: CSI Feedback Mechanism for Scheduling and Configuration

In 5G-NR, PTRS has low density in the frequency domain, with one subcarrier per 2 or 4 resource blocks (RBs), and high density in time domain, with one per 1, 2, or 4 OFDM symbols. The highest time domain density is per OFDM symbol but cannot go beyond to sub-symbols, as opposed to the phase tracking carrier. The density configuration of the PTRS uses a combination of implicit and explicit signaling using two tables, illustrated as examples in FIG. 18A and FIG. 18B.

FIG. 18A illustrates an example table showing the time density of PT-RS as a function of a scheduled MCS. The time density is based on MCS thresholds. FIG. 18B illustrates an example table showing the frequency density of PT-RS as a function of scheduled bandwidth. The frequency density is based on the bandwidth (BW), in a number of RB thresholds. The UE 106 reports preferred thresholds. The base station 102 configures the actual used threshold through radio resource communication (RRC) configuration. The actual time/frequency density is then implicitly determined by comparing the scheduled MCS and BW with the threshold, while thresholds are determined explicitly by the network via the RRC configuration.

There are several different aspects when comparing PTC and OFDM-PTRS. PTC has a much greater capability of canceling the phase noise. In particular, PTC has the capability of compensating for the ICI effect of the phase noise since the PTC's spectrum overhead is larger than that of OFDM-PTRS. Therefore, the existing semi-static BW/MCS threshold of PT-RS for a data channel may not be sufficient for scheduling and configuring the PTC.

FIG. 19 illustrates an example block diagram showing 7 CCs, with 5 data CCs and two PTC in two phase synchronized component carrier phase groups. Different phase tracking carrier configurations, including frequency location and bandwidth of the single carrier PTC (SC-PTC) may result in different phase noise impact to the demodulation and decoding capability depending on the operating signal to noise ratio (SNR) and the phase noise characteristics. Frequency location configuration can be decided based on the information from phase synchronized component carriers (e.g. CC1 and CC2 in Group 1 or CC4, CC5, and CC7 in Group 2) from the perspective of all the active UEs and their serving BSs.

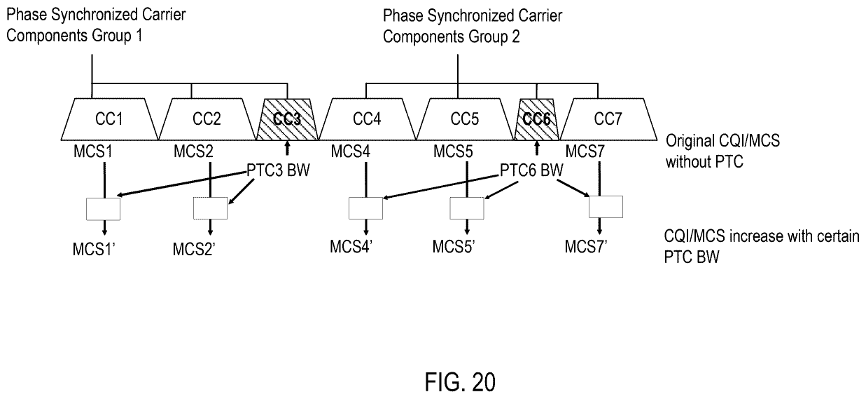

### FIG. 20: Network Information for PTC Scheduling and Configuration

To perform PTC scheduling and configuration, the network 100 needs to know how much of a benefit the use of the PTC is to the UE for each data CC, if a particular BW of the PTC is configured within a given phase synchronized component carrier group. This may be determined based on an MCS increase provided by the PTC BW. The MCS increase depends on the original MCS (SNR) of a data CC, the PTC BW, and the overall phase noise and PSD characteristics. The benefits are greater when the original MCS is higher.

FIG. 20 shows the original channel quality indicator (CQI)/MCS without PTC, and the CQI/MCS increase with a certain PTC BW. In this example, the CC3 is a PTC for Phase Synchronization Component Carrier Group 1, and CC6 is a PTC for Phase Synchronization Component Carrier Group 2. Accordingly, the bandwidth of CC3 (PTC3 BW) and the bandwidth of CC6 (PTC6 BW) are selected based on the increase in MSC, with the resulting MSC1′, MSC2′, MSC4′, MSC5′, and MSC7′.

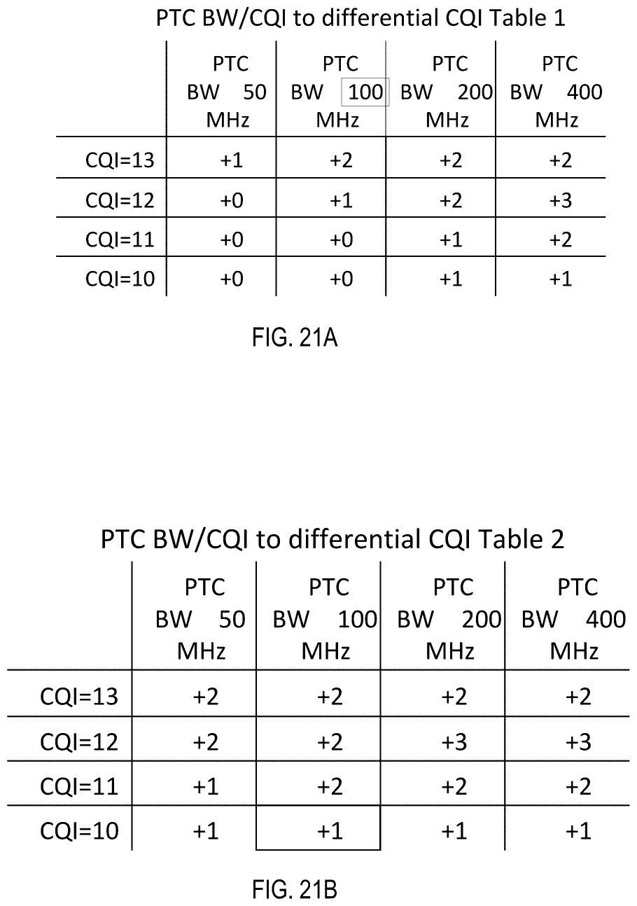

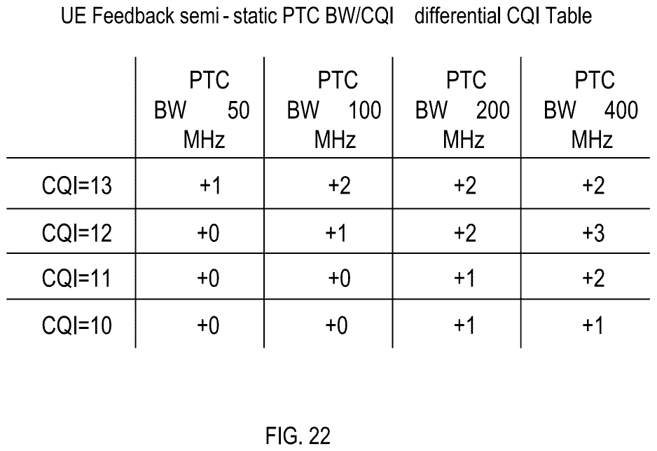

### FIGS. 21-22: Tables Used for Methods for CSI Feedback for Scheduling and Configuration

In a first method for CSI feedback for scheduling and configuration, predefined static PTC BW/CQI tables can be defined with associated phase noise capabilities. FIGS. 21A and 21B show example tables of PTC BW/CQI to differential CQI for various PTC bandwidths. The UE 106 can indicate to the base station 102 which table to be used. For CQI lower than the minimum CQI in the table, the base station can assume no benefits of scheduling RS with the PTC to this UE.

Through the UE's 106 CQI report on each data CC and using the PTC BW/CQI table, the base station 102 may evaluate the throughput with and without designating a CC as a PTC for the scheduling decision.

In a second method, the base station 102 can trigger the UE 106 to feedback information for the base station to create a semi-static PTC BW/CQI table for each phase synchronized component carrier group for this UE. FIG. 22 shows an example table of UE feedback of semi-static PTC BW/CQI-differential CQI table, for CQIs 10 to 13 for various PTC bandwidths. Compression can be done via feedback of the minimum CQI (10) and assume that a step=1. The differential CQI of each BW configuration is shown in the table in FIG. 22. The base station can use this table to evaluate the throughput with and without PTC of different BW for the base station's (or network's) scheduling decision.

### Example Apparatus of a UE

In accordance with some embodiments, an apparatus of a user equipment (UE) comprising: one or more processors, coupled to a memory, configured to The one or more processors are configured to receive, at the UE from a base station, a phase tracking carrier design comprising a phase tracking reference signal (PTRS) carried by a phase tracking carrier (PTC). The PTC comprises one or more component carriers of a plurality of component carriers used for carrier aggregation. The PTC is phase synchronized with one or more of the plurality of component carriers to form a phase synchronized component carrier group. The one or more processors are configured to estimate a phase drift based on the PTRS in the PTC; and compensate for the phase drift in one or more received signals of the component carriers in the phase synchronized component carrier group based on the estimated phase drift.

While a phase tracking carrier is used herein to designate a selected bandwidth for transmission of the PTRS, it is not intended to be limiting. Other bandwidth designations are also possible. For example, a bandwidth part (BWP) can be designated to transmit or receive the PTRS using a single-carrier waveform or multi-carrier waveform with a selected bandwidth, as previously discussed.

In some embodiments, the apparatus of the UE the PTRS can be received in the PTC on a single carrier waveform, wherein the single carrier waveform comprises: a Discrete Fourier Transform-Spread-Orthogonal Frequency Division Multiplexing (DFT-s-OFDM) waveform configured to carry the PTRS and data; or a time-domain Zadoff Chu sequence, or a modulated Golay sequence, a Gold sequence, or an m-sequence is configured to carry only the PTRS.

In some embodiments, the PTRS is carried on a cyclic prefix (CP)—orthogonal frequency division multiplexing (OFDM) sequence. In some embodiments, the PTC can be a wake-up carrier.

In some embodiments, the one or more processors of the apparatus of the UE are further configured to receive a control channel message indicating a selected component carrier of the plurality of component carriers is used as the PTC; receive data on the plurality of component carriers used for carrier aggregation; or receive data on the plurality of component carriers used for carrier aggregation that are not a PTC; or receive data on the plurality of component carriers used for carrier aggregation that are not a PTC using a multi-carrier Orthogonal Frequency Division Multiplexing (OFDM) waveform at a selected modulation and coding scheme (MCS).

In some embodiments, the PTC comprises: a same bandwidth as the plurality of component carriers used for carrier aggregation; or a smaller bandwidth than the plurality of component carriers used for carrier aggregation.

In some embodiments, the one or more processors are further configured to receive a center frequency and bandwidth of the PTC from a network, wherein the center frequency is within a frequency range of the one or more of the plurality of component carriers in the phase synchronized component carrier group.

In some embodiments, the one or more processors are further configured to identify, at the UE, a PTC channel quality indicator (CQI) table showing an increase in CQI for selected PTC bandwidths; send an indication of the identified PTC CQI table to the network to enable the network to select a bandwidth for the PTC based, at least in part, on the PTC CQI table; or send data in the PTC CQI table to a network for each phase synchronized component carrier group to enable the network to select a bandwidth of the PTC for the UE for a carrier aggregation.

### Example Apparatus of a Base Station

In some embodiments, an apparatus of a base station is disclosed. The apparatus comprises one or more processors, coupled to a memory, configured to: send to a user equipment (UE) a phase tracking reference signal (PTRS) carried by a phase tracking carrier (PTC). The PTC comprises one or more component carriers of a plurality of component carriers used for carrier aggregation. The PTC is phase synchronized with one or more of the plurality of component carriers to form a phase synchronized component carrier group. The one or more processors are further configured to send data signals or control channel signals to the UE using the component carriers in the phase synchronized component carrier group. The PTRS enables the UE to estimate a phase drift based on the PCT-RS and compensate for the phase drift in one or more of the data signals or control channel signals of the component carriers in the phase synchronized component carrier group based on the estimated phase drift.

In some embodiments, the PTRS is transmitted on a single carrier waveform that comprises: a Discrete Fourier Transform-Spread-Orthogonal Frequency Division Multiplexing (DFT-s-OFDM) waveform configured to carry the PTRS and data; or a time-domain Zadoff Chu sequence, or a modulated Golay sequence, a Gold sequence, or an m-sequence is configured to carry only the PTRS.

In some embodiments, the one or more processors of the apparatus of the BS are further configured to send data on the plurality of component carriers used for carrier aggregation; or send data on the plurality of component carriers used for carrier aggregation that are not a PTC; or send data on the plurality of component carriers used for carrier aggregation that are not a PTC using a multi-carrier Orthogonal Frequency Division Multiplexing (OFDM) waveform at a selected modulation and coding scheme (MCS).

In some embodiments, the PTC can be a wake-up carrier. The PTC can comprise a same bandwidth as the plurality of component carriers used for carrier aggregation; or a smaller bandwidth than the plurality of component carriers used for carrier aggregation.

In some embodiments, the one or more processors of the apparatus of the BS are further configured to send a center frequency and bandwidth of the PTC to the UE, wherein the center frequency is within a frequency range of the one or more of the plurality of component carriers in the phase synchronized component carrier group.

In some embodiments, the one or more processors of the apparatus of the BS are further configured to identify, at the UE, a PTC channel quality indicator (CQI) table showing an increase in CQI for selected PTC bandwidths; receive an indication of an identified PTC channel quality index (CQI) table to enable the network to select a bandwidth for the PTC based, at least in part, on the PTC CQI table; or receive data in the PTC CQI table from the UE for each phase synchronized component carrier group to enable the base station to select a bandwidth of the PTC for the UE for a carrier aggregation.

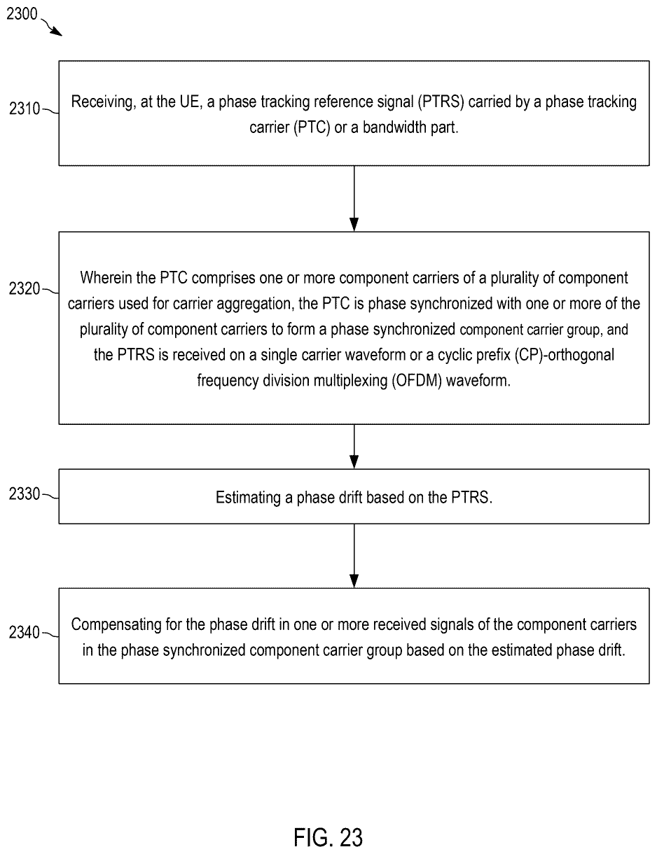

### FIG. 23: Flow Chart of Compensating for Phase Drift in Received Signals at a User Equipment (UE)

FIG. 23 illustrates a flow chart of a method 2300 for compensating for phase drift in received signals at a user equipment (UE), in accordance with some embodiments. The method 2300 shown in FIG. 23 may be used in conjunction with any of the systems, methods, or devices illustrated in the figures, among other devices. In various embodiments, some of the method elements shown may be performed concurrently, in a different order than shown, or may be omitted. Additional method elements may also be performed as desired.

In some embodiments, the method 2300 comprises receiving, at the UE, a phase tracking reference signal (PTRS) carried by a phase tracking carrier (PTC) or a bandwidth part, as shown in 2310. The PTC comprises one or more component carriers of a plurality of component carriers used for carrier aggregation. The PTC is phase synchronized with one or more of the plurality of component carriers to form a phase synchronized component carrier group. The PTRS is received on a single carrier waveform or a cyclic prefix (CP)-orthogonal frequency division multiplexing (OFDM) waveform, as shown in 2320. The method 2300 further comprises estimating a phase drift based on the PTRS, as shown in 2330. The method 2300 further comprises compensating for the phase drift in one or more received signals of the component carriers in the phase synchronized component carrier group based on the estimated phase drift, as shown in 2340.

In some embodiments, the single carrier waveform can comprise a Discrete Fourier Transform-Spread-Orthogonal Frequency Division Multiplexing (DFT-s-OFDM) waveform configured to carry the PTRS and data. Alternatively, the single carrier waveform can comprise a time-domain Zadoff Chu sequence, or a modulated Golay sequence, a Gold sequence, or an m-sequence is configured to carry only the PTRS.

In some embodiments, the method 2300 can further comprise receiving data on the plurality of component carriers used for carrier aggregation; or receiving data on the plurality of component carriers used for carrier aggregation that are not a PTC; or receiving data on the plurality of component carriers used for carrier aggregation that are not a PTC using a multi-carrier Orthogonal Frequency Division Multiplexing (OFDM) waveform at a selected modulation and coding scheme (MCS).

In some embodiments, the PTC can comprise a same bandwidth as the plurality of component carriers used for carrier aggregation; or a smaller bandwidth than the plurality of component carriers used for carrier aggregation.

In some embodiments, the method 2300 can further comprise receiving a center frequency and bandwidth of the PTC from a network, wherein the center frequency is within a frequency range of the one or more of the plurality of component carriers in the phase synchronized component carrier group.

In some embodiments, the method 2300 can further comprise identifying, at the UE, a PTC channel quality indicator (CQI) table showing an increase in CQI for selected PTC bandwidths; sending an indication of the identified PTC CQI table to a network to enable the network to select a bandwidth for the PTC based, at least in part, on the PTC CQI table; or sending data in the PTC CQI table to a network for each phase synchronized component carrier group to enable the network to select a bandwidth of the PTC for the UE for a carrier aggregation.

In one aspect, a baseband processor (e.g. baseband processor 600 or 604), or functionally similar component(s) whose function may include supporting baseband layer operations (e.g., to facilitate wireless communication between the UE 106 and other wireless devices) in the UE 106, can be configured to cause the UE 106 to perform any of the methods described herein. In another aspect, the UE 106 can have one or more processors (e.g. processors 402 and/or 600 or 604) coupled to a memory 406 or 604G to cause the user equipment 106 to perform any of the methods described herein. In another aspect, a baseband processor (e.g. baseband processor 600 or 604 can be configured to cause a base station 102 to perform one or more of the methods described herein. In another aspect, the base station 102 can have one or more processors 204 and/or 600 or 604 coupled to memory 260 or 604G configured to cause the base station 102 to perform any of the methods described herein. In another aspect, a computer program product, comprising computer instructions which, when executed by one or more processors, can perform any of the operations described herein.

Embodiments of the present disclosure may be realized in any of various forms. For example, some embodiments may be realized as a computer-implemented method, a computer readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus of a user equipment (UE) comprising:
one or more processors, coupled to a memory, configured to:
receive, at the UE from a base station, a phase tracking carrier design comprising a phase tracking reference signal (PTRS) carried by a phase tracking carrier (PTC);
wherein the PTC comprises one or more component carriers of a plurality of component carriers used for carrier aggregation;
wherein the PTC is phase synchronized with one or more of the plurality of component carriers to form a phase synchronized component carrier group; and
estimate a phase drift based on the PTRS in the PTC; and
compensate for the phase drift in one or more received signals of the component carriers in the phase synchronized component carrier group based on the estimated phase drift.

2. The apparatus of claim 1, wherein the PTRS is received in the PTC on a single carrier waveform, wherein the single carrier waveform comprises:
a Discrete Fourier Transform-Spread-Orthogonal Frequency Division Multiplexing (DFT-s-OFDM) waveform configured to carry the PTRS and data; or
a time-domain Zadoff Chu sequence, or a modulated Golay sequence, a Gold sequence, or an m-sequence is configured to carry only the PTRS.

3. The apparatus of claim 1, wherein:
the PTRS is carried on a cyclic prefix (CP)—orthogonal frequency division multiplexing (OFDM) sequence; or
the PTC is a wake-up carrier.

4. The apparatus of claim 1, wherein the one or more processors are further configured to:
receive a control channel message indicating a selected component carrier of the plurality of component carriers is used as the PTC;
receive data on the plurality of component carriers used for carrier aggregation; or
receive data on the plurality of component carriers used for carrier aggregation that are not a PTC; or
receive data on the plurality of component carriers used for carrier aggregation that are not a PTC using a multi-carrier Orthogonal Frequency Division Multiplexing (OFDM) waveform at a selected modulation and coding scheme (MCS).

5. The apparatus of claim 1, wherein the PTC comprises:
a same bandwidth as the plurality of component carriers used for carrier aggregation; or
a smaller bandwidth than the plurality of component carriers used for carrier aggregation.

6. The apparatus of claim 1, wherein the one or more processors are further configured to:
receive a center frequency and bandwidth of the PTC from a network, wherein the center frequency is within a frequency range of the one or more of the plurality of component carriers in the phase synchronized component carrier group.

7. The apparatus of claim 1, wherein the one or more processors are further configured to:
identify, at the UE, a PTC channel quality indicator (CQI) table showing an increase in CQI for selected PTC bandwidths;
send an indication of the identified PTC CQI table to a network to enable the network to select a bandwidth for the PTC based, at least in part, on the PTC CQI table; or
send data in the PTC CQI table to a network for each phase synchronized component carrier group to enable the network to select a bandwidth of the PTC for the UE for a carrier aggregation.

8. An apparatus of a base station, comprising:
one or more processors, coupled to a memory, configured to:
send to a user equipment (UE) a phase tracking reference signal (PTRS) carried by a phase tracking carrier (PTC);
wherein the PTC comprises one or more component carriers of a plurality of component carriers used for carrier aggregation;
wherein the PTC is phase synchronized with one or more of the plurality of component carriers to form a phase synchronized component carrier group; and
send data signals or control channel signals to the UE using the component carriers in the phase synchronized component carrier group;
wherein the PTRS enables the UE to estimate a phase drift based on the PTRS and compensate for the phase drift in one or more of the data signals or control channel signals of the component carriers in the phase synchronized component carrier group based on the estimated phase drift.

9. The apparatus of claim 8, wherein the PTRS is transmitted on a single carrier waveform that comprises:
a Discrete Fourier Transform-Spread-Orthogonal Frequency Division Multiplexing (DFT-s-OFDM) waveform configured to carry the PTRS and data; or
a time-domain Zadoff Chu sequence, or a modulated Golay sequence, a Gold sequence, or an m-sequence is configured to carry only the PTRS.

10. The apparatus of claim 8, wherein the one or more processors are further configured to:
send data on the plurality of component carriers used for carrier aggregation; or
send data on the plurality of component carriers used for carrier aggregation that are not a PTC; or
send data on the plurality of component carriers used for carrier aggregation that are not a PTC using a multi-carrier Orthogonal Frequency Division Multiplexing (OFDM) waveform at a selected modulation and coding scheme (MCS).

11. The apparatus of claim 8, wherein the PTC is a wake-up carrier.

12. The apparatus of claim 8, wherein the PTC comprises:
a same bandwidth as the plurality of component carriers used for carrier aggregation; or
a smaller bandwidth than the plurality of component carriers used for carrier aggregation.

13. The apparatus of claim 8, wherein the one or more processors are further configured to:
send a center frequency and bandwidth of the PTC to the UE, wherein the center frequency is within a frequency range of the one or more of the plurality of component carriers in the phase synchronized component carrier group.

14. The apparatus of claim 8, wherein the one or more processors are further configured to:
identify, at the UE, a PTC channel quality indicator (CQI) table showing an increase in CQI for selected PTC bandwidths;
receive an indication of an identified PTC channel quality index (CQI) table to enable the network to select a bandwidth for the PTC based, at least in part, on the PTC CQI table; or
receive data in the PTC CQI table from the UE for each phase synchronized component carrier group to enable the base station to select a bandwidth of the PTC for the UE for a carrier aggregation.

15. A method of compensating for phase drift in received signals at a user equipment (UE) comprising:
receiving, at the UE, a phase tracking reference signal (PTRS) carried by a phase tracking carrier (PTC) or a bandwidth part;
wherein the PTC comprises one or more component carriers of a plurality of component carriers used for carrier aggregation;
wherein the PTC is phase synchronized with one or more of the plurality of component carriers to form a phase synchronized component carrier group; and
wherein the PTRS is received on a single carrier waveform or a cyclic prefix (CP)-orthogonal frequency division multiplexing (OFDM) waveform;
estimating a phase drift based on the PTRS; and
compensating for the phase drift in one or more received signals of the component carriers in the phase synchronized component carrier group based on the estimated phase drift.

16. The method of claim 15, wherein the single carrier waveform comprises:
a Discrete Fourier Transform-Spread-Orthogonal Frequency Division Multiplexing (DFT-s-OFDM) waveform configured to carry the PTRS and data; or
a time-domain Zadoff Chu sequence, or a modulated Golay sequence, a Gold sequence, or an m-sequence is configured to carry only the PTRS.

17. The method of claim 15, further comprising:
receiving data on the plurality of component carriers used for carrier aggregation; or
receiving data on the plurality of component carriers used for carrier aggregation that are not a PTC; or
receiving data on the plurality of component carriers used for carrier aggregation that are not a PTC using a multi-carrier Orthogonal Frequency Division Multiplexing (OFDM) waveform at a selected modulation and coding scheme (MCS).

18. The method of claim 15, wherein the PTC comprises:
a same bandwidth as the plurality of component carriers used for carrier aggregation; or
a smaller bandwidth than the plurality of component carriers used for carrier aggregation.

19. The method of claim 15, further comprising:
receiving a center frequency and bandwidth of the PTC from a network, wherein the center frequency is within a frequency range of the one or more of the plurality of component carriers in the phase synchronized component carrier group.

20. The method of claim 15, further comprising:
identifying, at the UE, a PTC channel quality indicator (CQI) table showing an increase in CQI for selected PTC bandwidths;
sending an indication of the identified PTC CQI table to a network to enable the network to select a bandwidth for the PTC based, at least in part, on the PTC CQI table; or
sending data in the PTC CQI table to a network for each phase synchronized component carrier group to enable the network to select a bandwidth of the PTC for the UE for a carrier aggregation.
